(19) United States
(12) Patent Application Publication
(10) Pub. No.: US 2007/0098286 A1
(43) Pub. Date: May 3, 2007

(54) Image coding apparatus and image processing system

(75) Inventor: Kaoru Kotoda, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/590,934

(22) Filed: Nov. 1, 2006

(30) Foreign Application Priority Data
Nov. 2, 2005 (JP) 2005-319258

(51) Int. Cl. G06K 9/36

(52) U.S. Cl. 382/239

(57) ABSTRACT

An image coding apparatus includes a distortion determining unit, a plurality of compression operating units, and a selecting unit. The distortion determining unit determines an amount of optical distortion of an image associated with a set of input image data. The plurality of compression operating units has different compression and coding characteristics from each other. Each of the plurality of compression operating units is configured to convert at least a part of the set of input image data into a corresponding set of compressed and coded data. The selecting unit selects one of the plurality of compression operating units with reference to the result of determination by the distortion determining unit.

### BACKGROUND OF THE INVENTION

1. Field of the Invention

The present invention generally relates to an image coding apparatus and an image processing system. More specifically, the present invention relates to an image coding apparatus for compressing and coding image data, and an image processing system including the image coding apparatus and an image decoding apparatus for decoding the compressed and coded image data. The present invention also relates to an image coding apparatus and an image processing system, which are suitable for transmitting and storing images that have been picked up by an image pickup device such as digital cameras, image pickup modules for mobile phones, and monitoring cameras.

Priority is claimed on Japanese Patent Application No. 2005-319258, filed Nov. 2, 2005, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

An image pickup device for capturing electronic images such as digital cameras, image pickup modules for mobile phones, and monitoring cameras utilizes an electronic zooming system that changes an angle of view without using an optical zooming lens. The electronic zooming system changes the angle of view without using any mechanical mechanism. In order to change the angle of view, the electronic zooming system cuts a part of the image and magnifies the cut part of the image while the magnified part has a deteriorated quality of image.

Japanese Unexamined Patent Application, First Publication, No. 10-233950 discloses a conventional technique for suppressing the deterioration of the image quality. An optical system may have a distortion that compresses a side portion or side portions adjacent to the periphery of an optical image. An optical image captured using this optical system contains the side-distortion of compression. Cutting and correcting processes are performed to the side-distortion-containing image thereby obtaining an electronically zoomed high quality image.

Digital cameras, image pickup modules for mobile phones, and monitoring cameras store the obtained electronic images in an internal memory, transmits the obtained electronic images on transmission paths such as a wireless or wired network, stores the transmitted images, and displays the transmitted images. The storage device has an upper limit of storage capacity. The transmission path also has an upper limit of the transmission rate. The image data is often compressed and coded to reduce the data size thereof before storing or transmitting the compressed and coded image data.

Japanese Patent No. 3550046 discloses a conventional system for compressing and transmitting an image that has been captured using the optical system having the above-described optical distortion. The obtained image is divided into a plurality of partial image blocks depending upon the distortion. The partial image blocks are given different priorities. The partial image blocks are sequentially transmitted in the order of the given priorities, thereby reducing the image size on the transmission. This ensures a real time display of the captured image and also realizes a high frame rate.

### SUMMARY OF THE INVENTION

In accordance with a first aspect of the present invention, an image coding apparatus may include, but is not limited to, a distortion determining unit, a plurality of compression operating units, and a selecting unit. The distortion determining unit may be configured to determine an amount of optical distortion of an image associated with a set of input image data. The plurality of compression operating units has different compression and coding characteristics from each other. Each of the plurality of compression operating units may be configured to convert at least a part of the set of input image data into a corresponding set of compressed and coded data. The selecting unit may be configured to select one of the plurality of compression operating units with reference to the result of determination by the distortion determining unit.

The image coding apparatus may further include a block-dividing unit configured to divide the set of input image data into a plurality of divided blocks. The distortion determining unit may be configured to determine the amount of optical distortion for each of the plurality of divided blocks. The plurality of compression operating units may be configured to convert a part of the set of input image data for each of the plurality of divided blocks.

The image coding apparatus may further include a selection result storing unit, and a selection signal generating unit. The selection result storing unit may be configured to store a result of selection by the first selecting unit for each of the plurality of divided blocks. The selection signal generating unit may be configured to generate a selection signal that selects one of the plurality of compression operating units for converting a current block into a set of compressed and coded data, based on the result of determination by the distortion determining unit for the current block and based on the result of selection supplied from the selection result storing unit for a block adjacent to the current block.

The selecting unit may include a flag output unit, a normal compression operating unit, and a selector. The flag output unit is adapted to output a flag signal that shows the type of the set of image data. The normal compression operating unit may be configured to convert the set of image data into a set of compressed and coded data by a single compression and coding characteristic. The selector may be configured to select one of the normal compression operating unit and the plurality of compression operating units based on the flag signal.

In accordance with a second aspect of the present invention, an image processing system may include, but is not limited to, an image coding apparatus, and an image decoding apparatus. The image coding apparatus may further includes a distortion determining unit, a plurality of compression operating units, a compression and coding selecting unit, and a normal compression operating unit. The distortion determining unit may be configured to determine an amount of optical distortion of an image associated with a set of input image data. The plurality of compression operating units may have different compression and coding characteristics from each other. Each of the plurality of compression operating units may be configured to convert at least a part of the set of input image data into a first set of compressed and coded data. The compression and coding selecting unit may be configured to select one of the plurality of compression operating units with reference to the result of determination by the distortion determining unit. The normal compression operating unit may be configured to convert the set of image data into a second set of compressed and coded data by a single compression and coding characteristic. The image decoding apparatus may further include a plurality of decompression operating units, a decompression selecting unit, a normal decompression unit, an image replacing unit, and a selector. The plurality of decompression operating units may have decompression characteristics being different from each other and corresponding to the compression and coding characteristics of the plurality of compression operating units respectively. Each of the plurality of decompression operating units may be configured to convert the first set of compressed and coded data into a second set of decompressed image data. The decompression selecting unit may be configured to select one of the plurality of decompression operating units. The selected one decompression operating unit has a decompression characteristic that corresponds to the compression and coding characteristic of the selected one compression operating unit. The normal decompression unit may be configured to convert the second set of compressed and coded data into a second set of decompressed image data. The image replacing unit may be configured to replace a corresponding portion of the second set of decompressed image data that corresponds to a predetermined area of image into the first set of decompressed image data that corresponds to the predetermined area of image, thereby generating a third set of decompressed image data. The selector may be configured to select the second set of decompressed image data or the third set of decompressed image data, based on a mode signal input from the outside.

In accordance with a third aspect of the present invention, an image processing system may include an image coding apparatus, and an image decoding apparatus. The image coding apparatus may further include a distortion determining unit, a plurality of compression operating units, and a compression and coding selecting unit, a plurality of decompression operating units, a decompression selecting unit, and an image connecting unit. The distortion determining unit may be configured to determine an amount of optical distortion of an image associated with a set of input image data. The plurality of compression operating units may have different compression and coding characteristics from each other, each of the plurality of compression operating units being configured to convert at least a part of the set of input image data into a set of compressed and coded data. The compression and coding selecting unit may be configured to select one of the plurality of compression operating units with reference to the result of determination by the distortion determining unit. The image decoding apparatus may further include a plurality of decompression operating units, a decompression selecting unit, and an image connecting unit. The plurality of decompression operating units may have decompression characteristics being different from each other and corresponding to the compression and coding characteristics of the plurality of compression operating units respectively. Each of the plurality of decompression operating units may be configured to convert the set of compressed and coded data into a set of decompressed image data. The decompression selecting unit may be configured to select one of the plurality of decompression operating units. The selected one decompression operating unit has a decompression characteristic that corresponds to the compression and coding characteristic of the selected one compression operating unit. The image connecting unit may be configured to connect the sets of decompressed image data.

These and other objects, features, aspects, and advantages of the present invention will become apparent to those skilled in the art from the following detailed descriptions taken in conjunction with the accompanying drawings, illustrating the embodiments of the present invention.

### BRIEF DESCRIPTION OF THE DRAWINGS

Referring now to the attached drawings which form a part of this original disclosure:

FIG. 1 is a block diagram illustrating a configuration of a recording and reproducing system as an image processing system including an image coding apparatus in accordance with a first preferred embodiment of the present invention;

FIG. 2 is a block diagram illustrating a configuration of the coding unit included in the image processing system shown in FIG. 1;

FIG. 3 is a schematic perspective view illustrating a configuration of a distortion optical element included in the optical system included in the image processing system shown in FIG. 1;

FIG. 4A is a view illustrating an example of an object image;

FIG. 4B is a view illustrating an example of a focused image that is formed by captures the object image shown in FIG. 4A by the optical system shown in FIG. 1;

FIG. 5A is a view illustrating an example of an image captured by a distortion optical system having a distortion optical element;

FIG. 5B is a view illustrating an example of an image captured by a distortion-free optical system;

FIG. 5C is a view illustrating an example of a zoomed image obtained by the distortion optical system having the distortion optical element;

FIG. 5D is a view illustrating an example of a zoomed image obtained by the distortion-free optical system;

FIG. 6 is a block diagram illustrating a configuration of the decoding unit included in the image processing system shown in FIG. 1;

FIG. 7 is a block diagram illustrating a configuration of the image processing unit included in the coding unit shown in FIG. 2;

FIG. 8A is a view illustrating an example of the distortion-containing image that is supplied from the image processing unit shown in FIG. 2;

FIG. 8B is a view illustrating an example of image blocks that have been obtained by the block-dividing unit shown in FIG. 2 which divides the distortion-containing image of FIG. 8A;

FIG. 9A is a view illustrating an example of the distortion-corrected image that is supplied from the image processing unit shown in FIG. 2;

FIG. 9B is a view illustrating an example of image blocks that have been obtained by the block-dividing unit shown in FIG. 2 which divides the distortion-corrected image of FIG. 9A;

FIG. 10 is a block diagram illustrating a configuration of the distortion determining unit included in the coding unit shown in FIG. 2;

FIG. 11 is a block diagram illustrating a configuration of the block-dividing unit included in the coding unit shown in FIG. 2;

FIG. 12 is a view illustrating a method of dividing the processed image data into a plurality of image blocks by the block-dividing unit shown in FIG. 11;

FIG. 13 is a block diagram illustrating a configuration of the compressing and coding unit included in the coding unit shown in FIG. 2;

FIG. 14 is a timing chart illustrating waveforms of the block-related information signal, the block image data, the compression-selecting signal, the selective compression-operation controlling signal, a first block-selecting signal input to the selective compression operating unit, and a second block-selecting signal input to the selective compression-operation controlling unit;

FIG. 15 is a block diagram illustrating a configuration of the decompressing unit that is included in the decoding unit shown in FIG. 6;

FIG. 16 is a view illustrating decompressed images generated by the decompressing unit shown in FIG. 15 in the normal decompression mode and the selective decompression mode;

FIG. 17 is a block diagram illustrating a configuration of the display image processing unit included in the decoding unit shown in FIG. 6;

FIG. 18 is a block diagram illustrating a configuration of an image processing system as a remote monitoring system that utilizes an image coding apparatus in accordance with a second embodiment of the present invention;

FIG. 19 is a block diagram illustrating a configuration of the coding unit 13 included in the remote monitoring system shown in FIG. 18;

FIG. 20A is a view illustrating an image captured by the optical system and the imager shown in FIG. 18;

FIG. 20B is a view illustrating an example of a plurality of blocks divided from the image of FIG. 20A by the block-dividing unit shown in FIG. 19;

FIG. 21 is a block diagram illustrating a configuration of the block-dividing unit included in the coding unit shown in FIG. 19;

FIG. 22 is a block diagram illustrating a configuration of the compression operation selecting unit included in the coding unit shown in FIG. 19;

FIG. 23 is a block diagram illustrating a configuration of the comparison operating unit included in the compression operation selecting unit shown in FIG. 22;

FIG. 24 is a view illustrating interrelationships among the block, the amount of distortion and the comparison operation selected by the compression operation selecting unit included in the comparison operating unit shown in FIG. 23;

FIG. 25 is a block diagram illustrating a configuration of the compressing and coding unit included in the coding unit shown in FIG. 19;

FIG. 26 is a block diagram illustrating a configuration of the decoding unit included in the image processing system shown in FIG. 18;

FIG. 27 is a block diagram illustrating a configuration of a modified compressing and coding unit included in the coding unit shown in FIG. 2; and

FIG. 28 is a timing chart illustrating waveforms of the block-related information signal, the block image data, the compression-selecting signal, the selective compression-operation controlling signal, a first block-selecting signal input to the selective compression operating unit, and a second block-selecting signal input to the selective compression-operation controlling unit.

### DETAILED DESCRIPTION OF THE INVENTION

Selected embodiments of the present invention will now be described with reference to the drawings. It will be apparent to those skilled in the art from this disclosure that the following descriptions of the embodiments of the present invention are provided for illustration only and not for the purpose of limiting the invention as defined by the appended claims and their equivalents.

First Embodiment:

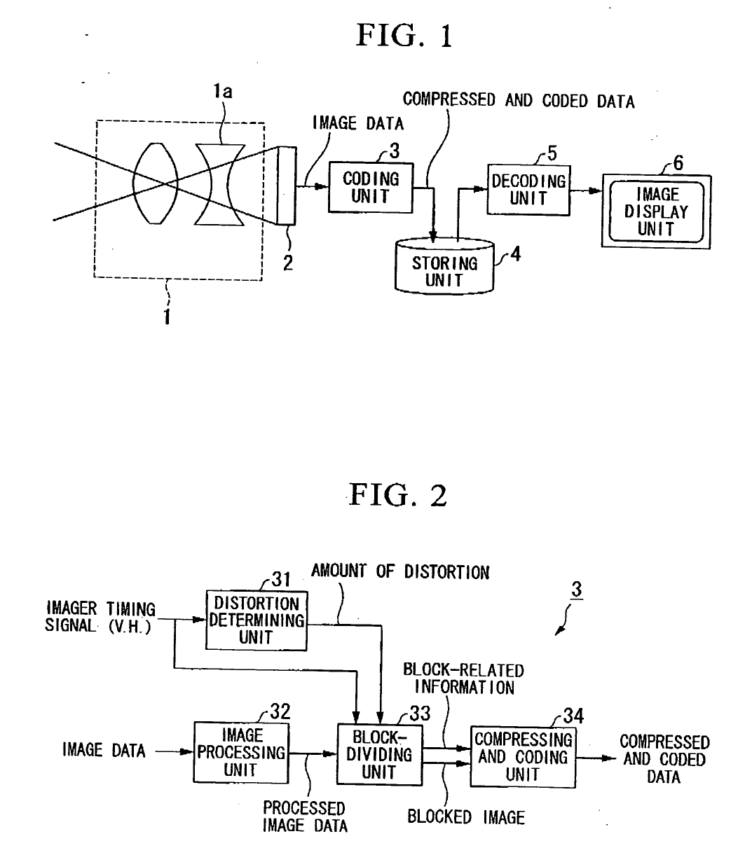

A first embodiment of the present invention will be described with reference to the accompanying drawings. FIG. 1 is a block diagram illustrating a configuration of a recording and reproducing system as an image processing system including an image coding apparatus in accordance with a first preferred embodiment of the present invention. The image processing system may include, but is not limited to, an optical system 1, an imager 2 performing as an image pickup device, a coding unit 3, a recording unit 4, a decoding unit 5, and an image display unit 6.

The optical system 1 includes an optical element 1a that provides an optical distortion to a captured optical image. The optical element 1a is used to allow an electronic zooming of the image data while keeping a high quality of image. This optical element 1a is disclosed in Japanese Unexamined Patent Application, First Publication, No. 10-233950.

The imager 2 performs as the image pickup device. The imager 2 converts an optical image captured by the optical system 1 into a set of electrical image data.

The coding unit 3 performs as an image coding apparatus. The coding unit 3 is configured to receive the set of image data from the imager 2. The coding unit 3 is configured to perform a variety of image processing to the received set of image data. The coding unit 3 is configured to compress and code the set of image data thereby generating a set of compressed and coded image data.

The storing unit 4 has a storage medium that stores compressed and coded data.

The decoding unit 5 is configured to read the compressed and coded data from the storing unit 4 and decode the compressed and coded data. The decoding unit 5 is configured to perform a variety of image processing.

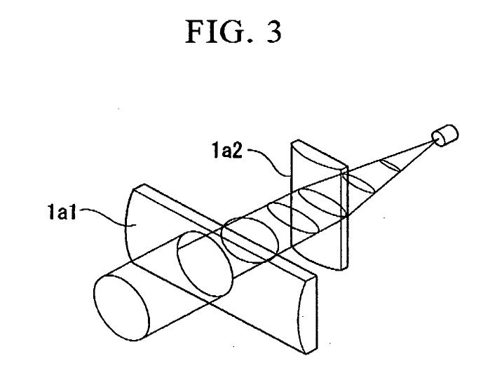

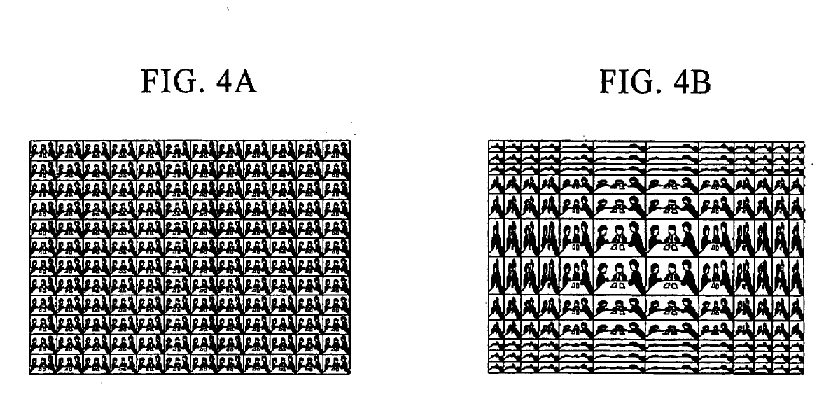

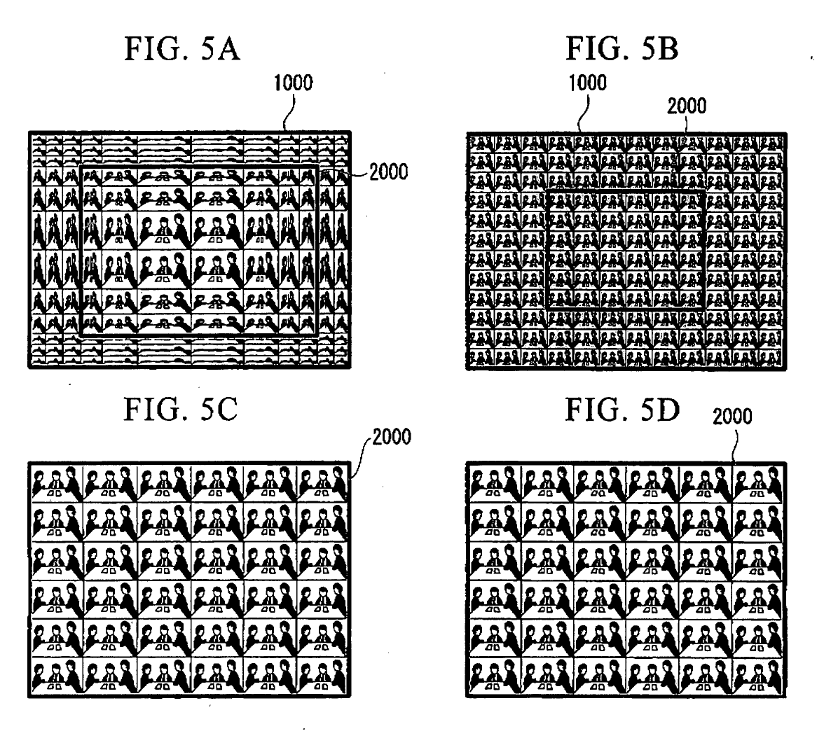

The image display unit 6 is configured to receive the decoded image data from the decoding unit 5 and to display an image based on the received decoded image data FIG. 2 is a block diagram illustrating a configuration of the coding unit 3 included in the image processing system shown in FIG. 1. FIG. 3 is a schematic perspective view illustrating a configuration of a distortion optical element 1a included in the optical system 1 included in the image processing system shown in FIG. 1. FIG. 4A is a view illustrating an example of an object image. FIG. 4B is a view illustrating an example of a focused image that is formed by captures the object image shown in FIG. 4A by the optical system 1 shown in FIG. 1. FIG. 5A is a view illustrating an example of an image captured by a distortion optical system having a distortion optical element. FIG. 5B is a view illustrating an example of an image captured by a distortion-free optical system. FIG. 5C is a view illustrating an example of a zoomed image obtained by the distortion optical system having the distortion optical element. FIG. 5D is a view illustrating an example of a zoomed image obtained by the distortion-free optical system.

The configuration of the distortion optical element 1a will be described with reference to FIG. 3. Electronic zooming using the optical system 1 including the distortion optical element 1a will be described with reference to FIGS. 4A, 4B, 5A, 5B, 5C and 5D. Some different types of distortion optical systems for causing an optical compression at the side area of an image have been known, wherein the side area of the image means a non-central area that is adjacent to a periphery of the image. Japanese Unexamined Patent Application, First Publication, No. 10-233950 discloses an example of the coaxial optical system.

Another type of optical system using cylindrical lenses will be described as an example of the distortion optical system. The distortion optical system 1a shown in FIG. 1 uses two cylindrical lenses 1a1 and 1a2 that are shown in FIG. 3. FIG. 4A shows an example of the object image that is free of any distortion, or compression. FIG. 4B shows a focused image having a compressed side area that has been captured by the optical system 1 including the distortion optical element 1a. The combination of the cylindrical lenses 1a1 and 1a2 compresses the side area of the image of FIG. 4A so that the focused image of FIG. 4B has a compressed side area.

FIGS. 5A, 5B, 5C and 5D show the processes for cutting an image captured by the imager 2 and performing electronic zooming. FIG. 5A shows a distortion-containing image captured by an optical system 1 including a distortion optical element 1a. FIG. 5C shows an example of an electronically zoomed image obtained by zooming a center area 2000, except for the side area 1000, of the distortion-containing image shown in FIG. 5A. FIG. 5B shows a substantially distortion-free image captured by a normal distortion-free optical system. FIG. 5D shows an example of an electronically zoomed image obtained by zooming a center area 2000, except for the side area 1000, of the substantially distortion-free image shown in FIG. 5B. FIGS. 5A, 5B, 5C and 5D show that the center area 2000 to be zoomed up of the distortion-containing image captured by the distortion-containing optical system 1 is larger in area than the center area 200 to be zoomed up of the substantially distortion-free image captured by the substantially distortion-free optical system, provided that the electrically zoomed images have the same angle of view.

The imager that has usually been used has a regular alignment of pixels of sensors that the sensors are disposed at a constant pitch. The number of the pixels is proportional to the area of the center area of the captured image. The center area 2000 to be zoomed up of the distortion containing image shown in FIG. 5A is larger in area than the center area 2000 to be zoomed up of the substantially distortion-free image shown in FIG. 5B. The number of the pixels disposed on the center area 2000 of the distortion-containing image shown in FIG. 5A is larger than the number of the pixels disposed on the center area 2000 of the substantially distortion-free image shown in FIG. 5B. Increasing the number of pixels increases the quality of the image. The electronically zoomed up image shown in FIG. 5C would be higher in quality of image than the electronically zoomed up image shown in FIG. 5D.

The electronic zooming process can be performed either after the decoding process or before the compressing and coding processes. The electronic zooming process can be performed while decoding the image data, thereby obtaining an image of an optional magnification. The electronic zooming process can be performed while coding the image data. In this case, the electronically zoomed up image is compressed and coded to reduce the data size, before the compressed and coded image data with the reduced data size is then stored. The image processing system in accordance with the first embodiment of the present invention is configured to select any one of first and second electronic zoom modes. In the first electronic zoom mode, the electronic zooming process is performed while coding the image data. In the second electronic zoom mode, the electronic zooming process is performed while decoding the image data. A user or an operator can optionally select any one of the first and second electronic zoom modes.

The image processing system as the recording and reproducing system in accordance with the present invention will be described. The imager 2 receives the optical image transmitted through the optical system 1 and converts the optical image to a set of electronic image data. The coding unit 3 is functionally coupled to the imager 2 to receive the set of electronic image data. FIG. 2 shows the configuration of the coding unit 3. The configuration of the coding unit 3 will be described with reference to FIG. 2. The coding unit 3 may include, but is not limited to, a distortion determining unit 31, an image processing unit 32, a block-dividing unit 33, and a compressing and coding unit 34.

The image processing unit 32 is functionally coupled to the imager 2 to receive the set of electronic image data from the imager 2. The image processing unit 32 is configured to perform a predetermined set of image processes for the set of electronic image data, thereby generating a set of processed image data. Typical examples of the image processes may include, but are not limited to, filtering process, white balance process, and gamma correction process.

The distortion determining unit 31 is functionally coupled to the imager 2 to receive an imager timing signal (V.H.) from the imager 2. The distortion determining unit 31 is configured to determine the amount of optical distortion contained in an image that corresponds to the set of electronic image data and generate a distortion signal that represents the determined amount of optical distortion, wherein the determination is made based on the imager timing signal (V.H.).

The block-dividing unit 33 is functionally coupled to the imager 2 to receive the imager timing signal (V.H.) from the imager 2. The block-dividing unit 33 is also functionally coupled to the distortion determining unit 31 to receive the distortion signal from the distortion determining unit 31. The block-dividing unit 33 is also functionally coupled to the image processing unit 32 to receive the set of processed image data from the image processing unit 32. The block-dividing unit 33 is configured to divide the set of processed image data into a plurality of image blocks, thereby generating the plurality of image blocks and a set of block-related information. The dividing process is performed based on the imager timing signal (V.H.) and the distortion signal.

The compressing and coding unit 34 is functionally coupled to the block-dividing unit 33 to receive the plurality of image blocks and the set of block-related information from the block-dividing unit 33. The compressing and coding unit 34 is configured to compress and code the plurality of image blocks, thereby generating a set of compressed and coded data. The compressing and coding unit 34 may preferably include a plurality of compression operating units that have different compressing and coding performances or different compressing performances from each other. One of the plural image blocks is selected based on the distortion signal. One of the compression operating units is selected, based on the selected image block, to perform the compression operation for the selected image block. The compressing and coding unit 34 outputs and transmits the set of compressed and coded data to the storing unit 4 that is shown in FIG. 4.

Operations of the coding unit 3 will be described. The set of image data is input into the coding unit 3, wherein the image processing unit 32 performs a predetermined set of image processes such as filtering process, white balance process, and gamma correction process for the set of electronic image data, thereby generating a set of processed image data. The distortion determining unit 31 determines the amount of optical distortion contained in the image that corresponds to the set of electronic image data and generates the distortion signal that represents the determined amount of optical distortion, wherein the determination is made based on the imager timing signal (V.H.).

The set of processed image data is supplied from the image processing unit 32 to the block-dividing unit 33. The set of processed image data is divided by the block-dividing unit 33 into a plurality of image blocks, thereby generating the plurality of image blocks and a set of block-related information. The dividing process is performed based on the imager timing signal (V.H.) and the distortion signal. The plurality of image blocks is then supplied from the block-dividing unit 33 to the compressing and coding unit 34. The plurality of image blocks is compressed and coded by the compressing and coding unit 34, thereby generating the set of compressed and coded data. The set of compressed and coded data is then transmitted from the compressing and coding unit 34 to the storing unit 4 that is shown in FIG. 1. The compressing and coding unit 34 may preferably include a plurality of compression operating units that have different compressing and coding performances or different compressing performances from each other. One of the plural image blocks is selected based on the distortion signal. One of the compression operating units is selected, based on the selected image block, to perform the compression operation for the selected image block.

Detailed descriptions of the operations of the coding unit 3 will be made later.

As the compressing and coding method for the image data, irreversible compression methods are generally used. Typical examples of the irreversible compression methods may include, but are not limited to, JPEG and JPEG2000 for static images and MPEG for dynamic images. In accordance with those irreversible compression methods, image information is decomposed into frequency components so that visually least significant parts of the information can be deleted to increase the efficiency of the compressing and coding processes. Deletion of the visually least significant parts of the information decreases the amount of data. Excessive compression can cause undesired deterioration of the quality of image.

The present invention can be practiced independent from the irreversible compression method.

The compressed and coded data is output from the coding unit 3 and transmitted to the storing unit 4, wherein the storing unit stores the compressed and coded data The storing unit 4 can be realized by, but is not limited to, a memory card, The above descriptions are related to the sequential processes for picking up the image and recording the compressed and coded image data.

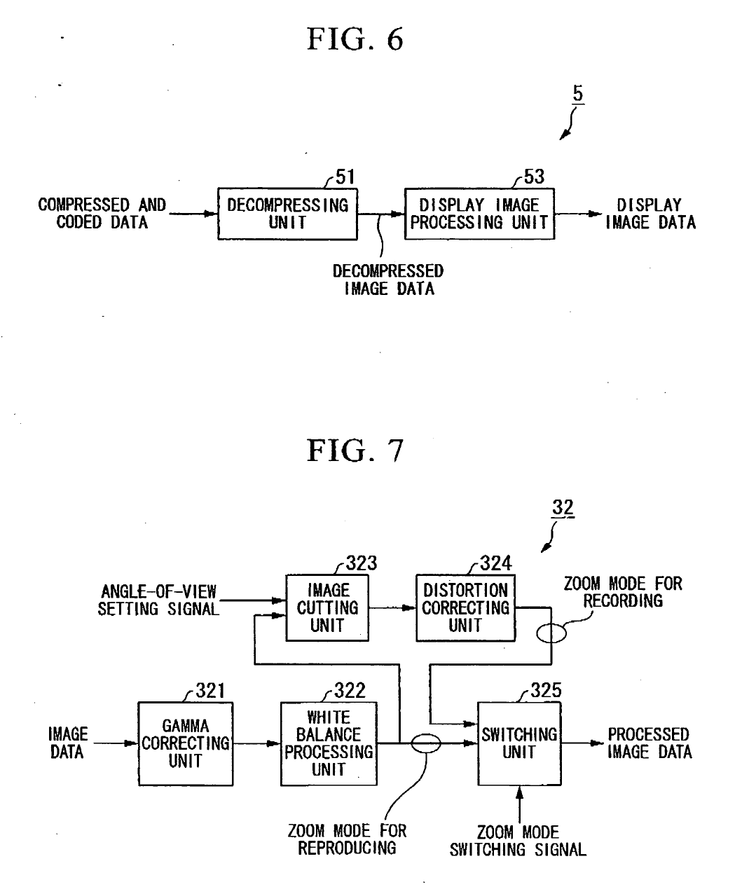

The following descriptions will be related to sequential operations for reading the compressed and coded image data in the storing unit 4 and displaying the image. As shown in FIG. 1, the compressed and coded data stored in the storing unit 4 is transmitted to the decoding unit 5. FIG. 6 is a block diagram illustrating a configuration of the decoding unit 5 included in the image processing system shown in FIG. 1. The decoding unit 5 may include, but is not limited to, a decompressing unit 51 and a display image processing unit 53.

The decompressing unit 51 is configured to receive an input of the set of compressed and coded data. The decompressing unit 51 is configured to extend the set of compressed and coded data, thereby generating a set of decompressed image data.

The display image processing unit 53 is functionally coupled to the decompressing unit 51 to receive the set of decompressed image data from the decompressing unit 51. The display image processing unit 53 is configured to apply filtering process and enlargement and/or reduction processes to the set of decompressed image data, thereby generating a set of display image data. If electronic zooming of the decoded image data is required, then the display image processing unit 53 is configured to apply not only filtering process and enlargement and/or reduction processes but also electronic zooming process to the decoded image data, thereby generating the set of display image data.

The following descriptions are related to detailed descriptions of the operations of the coding unit 3 while the image processing system performing to picking up an image. As shown in FIG. 1, the imager 2 generates the set of image data that represents the captured image. The set of image data is transmitted to the coding unit 3. In the coding unit 3, the image processing unit 32 receives the set of image data as shown in FIG. 2. The image processing unit 32 applies a predetermined variety of image processes. The predetermined variety of image processes may, if any, include the electronic zooming process.

FIG. 7 is a block diagram illustrating a configuration of the image processing unit 32 included in the coding unit 3 shown in FIG. 2. The image processing unit 32 may include, but is not limited to, a gamma correcting unit 321, a white balance processing unit 322, an image cutting unit 323, a distortion correcting unit 324, and a switching unit 325.

The gamma correcting unit 321 is configured to receive the set of image data from the imager 2. The gamma correcting unit 321 is configured to apply a gamma correction process to the set of image data, thereby generating a set of gamma-corrected image data.

The white balance processing unit 322 is functionally coupled to the gamma correcting unit 321 to receive the set of gamma-corrected image data from the gamma correcting unit 321. The white balance processing unit 322 is configured to apply a white balance correction to the set of gamma-corrected image data, thereby generating a set of white balance corrected image data.

The image cutting unit 323 is functionally coupled to the white balance processing unit 322 to receive the set of white balance corrected image data from the white balance processing unit 322. The image cutting unit 323 is also functionally coupled to an angle-of-view setting unit, which is not illustrated, to receive an angle-of-view setting signal from the angle-of-view setting unit. The angle-of-view setting signal designates a size of cut image. The image cutting unit 323 is configured to cut the image based on the image cutting size designated by the angle-of-view setting signal, thereby generating a cut image.

The distortion correcting unit 324 is functionally coupled to the image cutting unit 323 to receive the cut image from the image cutting unit 323. The distortion correcting unit 324 is configured to apply a distortion correction process to the cut image, thereby generating a set of distortion-corrected zoom image data.

The switching unit 325 is functionally coupled to the white balance processing unit 322 to receive the set of white balance corrected image data from the white balance processing unit 322. The switching unit 325 is also functionally coupled to the distortion correcting unit 324 to receive the set of distortion-corrected zoom image data from the distortion correcting unit 324. The switching unit 325 is configured to receive a zoom mode switching signal that indicates whether or not the zooming process is to be performed while storing the image data or reproducing the image data. The switching unit 325 is configured to select the set of distortion-corrected zoom image data as the set of processed image data if the zoom mode switching signal indicates that the zooming process is to be performed while storing the image data. The switching unit 325 is configured to select the set of distortion-corrected zoom image data as the set of processed image data if the zoom mode switching signal indicates that the zooming process is to be performed while storing the image data. The switching unit 325 is configured to select the set of white balance corrected image data as the set of processed image data if the zoom mode switching signal indicates that the zooming process is to be performed while reproducing the image data.

Operations of the image processing unit 32 will be described with reference to FIG. 7. The set of input image data is gamma-corrected by the gamma correcting unit 321. The set of gamma-corrected image data is then supplied to the white balance processing unit 322. The set of gamma-corrected image data is white-balance-corrected by the white balance processing unit 322.

The set of white balance corrected image data is supplied to both the image cutting unit 323 and the switching unit 325. The image cutting unit 323 cuts the image based on the image cutting size designated by the angle-of-view setting signal that has been transmitted from the angle-of-view setting unit that is not illustrated. The distortion correcting unit 324 corrects the distortion of the cut image to generate the set of distortion-corrected electronic zoom image data. The set of distortion-corrected electronic zoom image data is then input into the switching unit 325.

The switching unit 325 selects the set of distortion-corrected zoom image data if the zoom mode switching signal indicates that the zooming process is to be performed while storing the image data. The switching unit 325 also selects the set of distortion-corrected zoom image data if the zoom mode switching signal indicates that the zooming process is to be performed while storing the image data. The switching unit 325 selects the set of white balance corrected image data if the zoom mode switching signal indicates that the zooming process is to be performed while reproducing the image data.

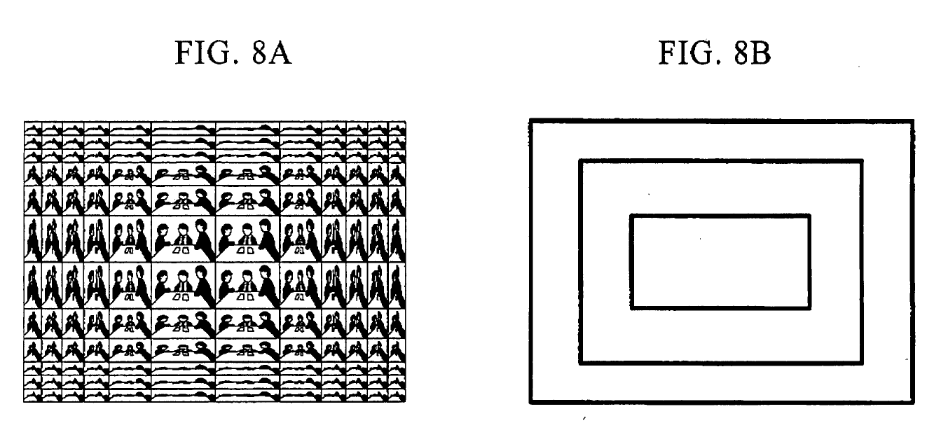

The set of processed image data is output from the image processing unit 32 and then input into the block-dividing unit 33. In the block-dividing unit, the set of processed image data is divided into a plurality of image blocks. FIG. 8A is a view illustrating an example of the distortion-containing image that is supplied from the image processing unit 32 shown in FIG. 2, provided that the selecting unit 325 shown in FIG. 7 has selected the set of white balance corrected image data in accordance with the zoom mode switching signal indicating that the zooming process is to be performed while reproducing the image data. FIG. 8B is a view illustrating an example of image blocks that have been obtained by the block-dividing unit 33 shown in FIG. 2 which divides the distortion-containing image of FIG. 8A, As shown in FIG. 8A, a center region of the object image is more dense in information than a peripheral region thereof. If the zoom mode switching signal indicates that the zooming process is to be performed while reproducing the image data, the distortion-containing image is divided by the block-dividing unit 33 into three image blocks 1, 2 and 3.

The block 1 extends over a peripheral region. The block 3 extends over a central region. The block 2 extends inside the block 1 and outside the block 3. The block 1 has a largest amount of information per unit area of the object image as compared to the blocks 2 and 3. The block 3 has a smallest amount of information per unit area of the object image as compared to the blocks 1 and 2. The block 2 has a middle mount of information per unit area of the object image, the middle amount of information per unit area being smaller than that of the block 1 and larger than that of the block 3. The block 1 has a lowest compression ratio as compared to the blocks 2 and 3. The lowest compression ratio causes that the image data is coded with a lowest reduction of the amount of information. The block 3 has a highest compression ratio as compared to the blocks 1 and 2. The highest compression ratio causes that the image data is coded with a highest reduction of the amount of information. The block 2 has a middle compression ratio that is higher than that of the block 1 and lower than that the block 3. The compression ratio is decided based on the amount of information per unit area.

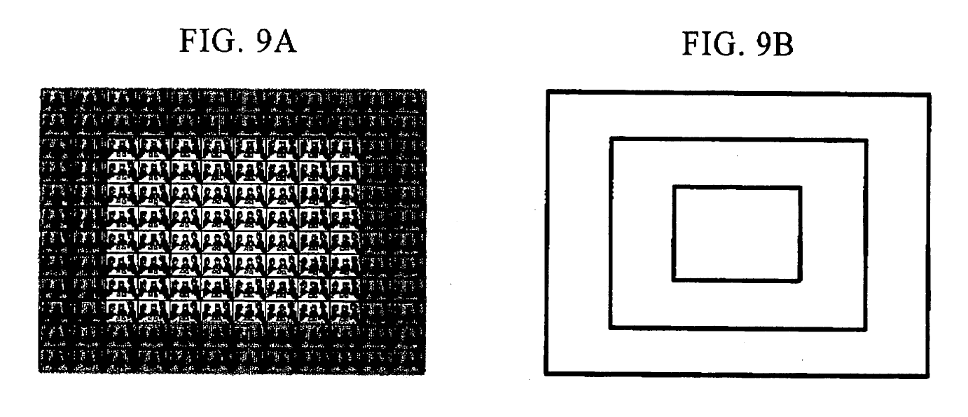

FIG. 9A is a view illustrating an example of the distortion-corrected image that is supplied from the image processing unit 32 shown in FIG. 2, provided that the selecting unit 325 shown in FIG. 7 has selected the set of distortion-corrected image data in accordance with the zoom mode switching signal indicating that the zooming process is to be performed while storing the image data. FIG. 9B is a view illustrating an example of image blocks that have been obtained by the block-dividing unit 33 shown in FIG. 2 which divides the distortion-corrected image of FIG. 9A.

As shown in FIG. 9A, a center region of the object image is less dense in information than a peripheral region thereof. If the zoom mode switching signal indicates that the zooming process is to be performed while storing the image data, the distortion-corrected image is divided by the block-dividing unit 33 into three image blocks 1, 2 and 3. The center region of the distortion-containing image has a lower distortion than the peripheral region. The center region of the distortion-containing image has a smaller enlargement ratio than the peripheral region thereof. In contrast, the peripheral region of the distortion-containing image has a smaller enlargement ratio than the center region thereof. The peripheral region of the distortion-containing image has been produced by a smaller number of pixels than that of the central region thereof. In contrast, the central region of the distortion-containing image has been produced by a larger number of pixels than that of the peripheral region thereof. The central region of the distortion-containing image has a larger mount of information per unit area than that of the peripheral region thereof. The peripheral region of the distortion-containing image has a larger mount of information per unit area than that of the central region thereof.

As shown FIG. 9B, the block 1 extends over a peripheral region. The block 3 extends over a central region. The block 2 extends inside the block 1 and outside the block 3. The block 1 has a smallest amount of information per unit area of the object image as compared to the blocks 2 and 3. The block 3 has a largest amount of information per unit area of the object image as compared to the blocks 1 and 2. The block 2 has a middle mount of information per unit area of the object image, the middle amount of information per unit area being larger than that of the block 1 and smaller than that of the block 3. The block 1 has a highest compression ratio as compared to the blocks 2 and 3. The block 3 has a lowest compression ratio as compared to the blocks 1 and 2 to prevent deterioration of the quality of image. The block 2 has a middle compression ratio that is lower than that of the block 1 and higher than that the block 3. The compression ratio is decided based on the amount of information per unit area.

In a case, JPEG can be used as a compression method to control the compression ratio. In accordance with JPEG a scaling factor is set as a parameter indicating a range of frequency subjected to the deletion during the compression and coding processes, thereby controlling the compression ratio. In accordance with this embodiment, different scaling factors are set for the blocks 1, 2 and 3. As described above, the block-dividing unit 33 performs the block-dividing process based on the amount of distortion that has been detected by the distortion determining unit 31.

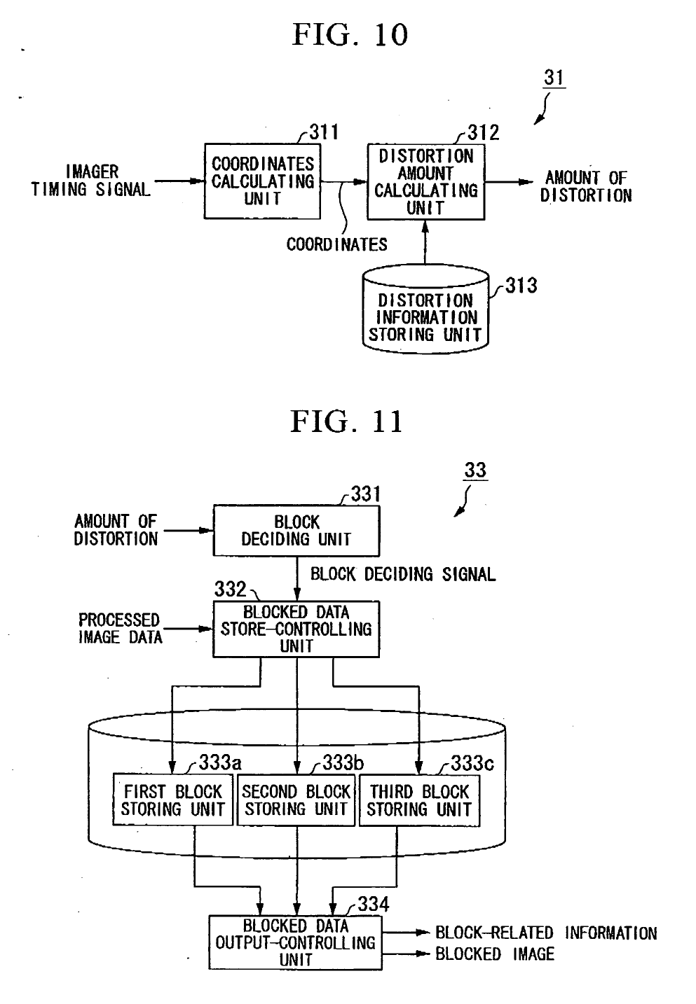

FIG. 10 is a block diagram illustrating a configuration of the distortion determining unit 31 included in the coding unit 3 shown in FIG. 2. The distortion determining unit 31 may include, but is not limited to, a coordinates calculating unit 311, a distortion amount calculating unit 312, and a distortion-information storing unit 313. The coordinates calculating unit 311 receives horizontal and vertical imager timing signals (H.V.) from the imager 2, wherein the horizontal and vertical imager timing signals (H.V.) are synchronized with the input image data. The coordinates calculating unit 311 is configured to calculate coordinates of the input image data, thereby generating the calculated coordinates of the input image data. The calculated coordinates of the input image data are defined in the coordinate space of the captured image. The calculation is made based on the horizontal and vertical imager timing signals (H.V.).

The distortion-information storing unit 313 stores a set of information related to the optical distortion of the optical system 1, which can be referred to as a set of optical distortion related information. A typical example of the set of optical distortion related information may include, but is not limited to, a set of information that defines correspondences between coordinates on the captured image and the amounts of distortion of the distortion-containing optical element 1a.

The distortion amount calculating unit 312 is functionally coupled to the distortion-information storing unit 313 to receive the set of optical distortion related information from the distortion-information storing unit 313. The distortion amount calculating unit 312 is also functionally coupled to the coordinates calculating unit 311 to receive the calculated coordinates of the input image data from the coordinates calculating unit 311. The distortion amount calculating unit 312 is configured to calculate an amount of distortion based on the set of optical distortion related information and the calculated coordinates of the input image data, thereby generating a calculated amount of distortion. The block-dividing unit 33 shown in FIG. 2 is functionally coupled to the distortion amount calculating unit 312 to receive the calculated amount of distortion. The block-dividing unit 33 is configured to perform the block-dividing process based on the calculated amount of distortion.

Operations of the distortion determining unit 31 will be described with reference to FIG. 10. In the distortion determining unit 31, the calculation of the coordinates of the input image data in the coordinates space of the captured image is made by the coordinates calculating unit 311 based on the horizontal and vertical imager timing signals (H.V.) from the imager 2, wherein the horizontal and vertical imager timing signals (H.V.) are synchronized with the input image data. The set of information that defines correspondences between coordinates on the captured image and the amounts of distortion of the distortion-containing optical element 1a has been stored in the distortion-information storing unit 313. The amount of distortion is calculated by the distortion amount calculating unit 312 based on the set of optical distortion related information and the calculated coordinates of the input image data. The calculated amount of distortion is transmitted to the block-dividing unit 33 so that the block-dividing unit 33 is configured to perform the block-dividing process based on the calculated amount of distortion.

FIG. 1 is a block diagram illustrating a configuration of the block-dividing unit 33 included in the coding unit 3 shown in FIG. 2. The block-dividing unit 33 may include, but is not limited to, a block-deciding unit 331, a blocked data store-controlling unit 332, a first block storing unit 333a, a second block storing unit 333b, a third block storing unit 333c, and a blocked data output-controlling unit 334.

The block-deciding unit 331 is functionally coupled to the distortion determining unit 31 shown in FIG. 2 to receive the calculated amount of distortion from the distortion determining unit 31. The block-deciding unit 331 is configured to compare the calculated amount of distortion to a predetermined threshold, thereby determining an extent including the calculated amount of distortion. The block-deciding unit 331 is configured to determine a block that belongs to the determined extent. The block-deciding unit 331 is configured to generate a block deciding signal based on the result of determination of the block.

The blocked data store-controlling unit 332 is functionally coupled to the image processing unit 32 shown in FIG. 2 to receive the set of processed image data from the image processing unit 32. The blocked data store-controlling unit 332 is functionally coupled to the block-deciding unit 331 to receive the block deciding signal from the block-deciding unit 331. The blocked data store-controlling unit 332 is configured to divide the set of processed image data into a plurality of image blocks.

The blocked data store-controlling unit 332 is functionally coupled to the first, second and third block storing units 333a, 333b, and 333c so as to store the plurality of divided image blocks in the first, second and third block storing units 333a, 333b, and 333c, respectively, based on the block deciding signal.

The blocked data output-controlling unit 334 is functionally coupled to each of the first, second and third block storing units 333a, 333b, and 333c so as to generate a set of block information and a blocked image for each of the plurality of divided image blocks. The set of block information indicates a block, to which the image data belongs. The compressing and coding unit 34 shown in FIG. 2 is functionally coupled to the blocked data output-controlling unit 334 to receive the image blocks.

Operations of the block-dividing unit 33 will be described with reference to FIG. 11. The calculated amount of distortion is output from the distortion determining unit 31 and then input into the block-deciding unit 331. In the block-deciding unit 331, the calculated amount of distortion is compared with the predetermined threshold. An extent including the calculated amount of distortion is determined to determine a block. A block deciding signal is generated by the block-deciding unit 331 based on the result of the determination of the block. The block deciding signal is transmitted to the blocked data store-controlling unit 332. The set of processed image data is output from the image processing unit 32 and input into the blocked data store-controlling unit 332. The set of processed image data is divided by the block-dividing unit 33 into the plurality of image blocks. The plurality of image blocks are stored in the first, second and third block storing units 333a, 333b, and 333c, respectively, based on the block deciding signal.

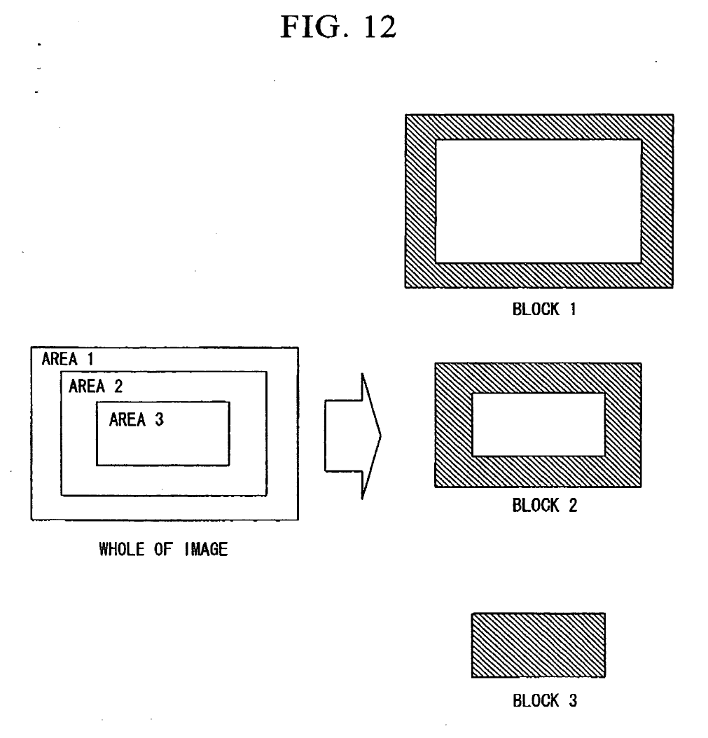

FIG. 12 is a view illustrating a method of dividing the processed image data into a plurality of image blocks by the block-dividing unit 33 shown in FIG. 11. The original processed image includes first, second and third regions 1, 2, and 3 which have first, second and third extents of the amount of distortion that are different from each other The first, second and third regions 1, 2, and 3 are set to be first, second, and third blocks 1, 2, and 3, respectively. The first, second, and third blocks 1, 2, and 3 correspond to different extents of the amount of distortion. The first, second, and third blocks 1, 2, and 3 are stored in the first, second and third block storing units 333a, 333b, and 333c, respectively. The blocked data output-controlling unit 334 generates a set of block information and a blocked image for each of the plurality of divided image blocks. The set of block information indicates a block, to which the image data belongs. The image blocks are output from the blocked data output-controlling unit 334 and input into the compressing and coding unit 34 shown in FIG. 2.

As described above, the first, second, and third blocks 1, 2, and 3 are subjected to different calculation operations in order to obtain a high quality compressed image. In a case, the image can be displayed quickly in the decompression operation. In this case, different compression operations applied to the different image blocks can reduce the process speed and can deteriorate response speed in operation. Preferably, the compressing and coding operations adapted to the first block 1 are applied to the whole image that includes the first, second and third blocks 1, 2, and 3, thereby generating a set of normally compressed and coded data. If the high speed display is required, then only the set of normally compressed and coded data is used to be displayed.

Namely, the second and third blocks 2 and 3 are subjected to the uniform compressing and coding operations adapted to the first block 1. In parallel to the compressing and coding operations adapted to the first block 1, another compressing and coding operations adapted to the second block 2 is applied to the second block 2, and still another compressing and coding operations adapted to the third block 3 is applied to the third block 3. If the high quality image is required to be reproduced, then the decompressed image from the selective compressing and coding data can be applied to the second and third blocks 2 and 3, instead of the decompressed image from the normal compressing and coding data.

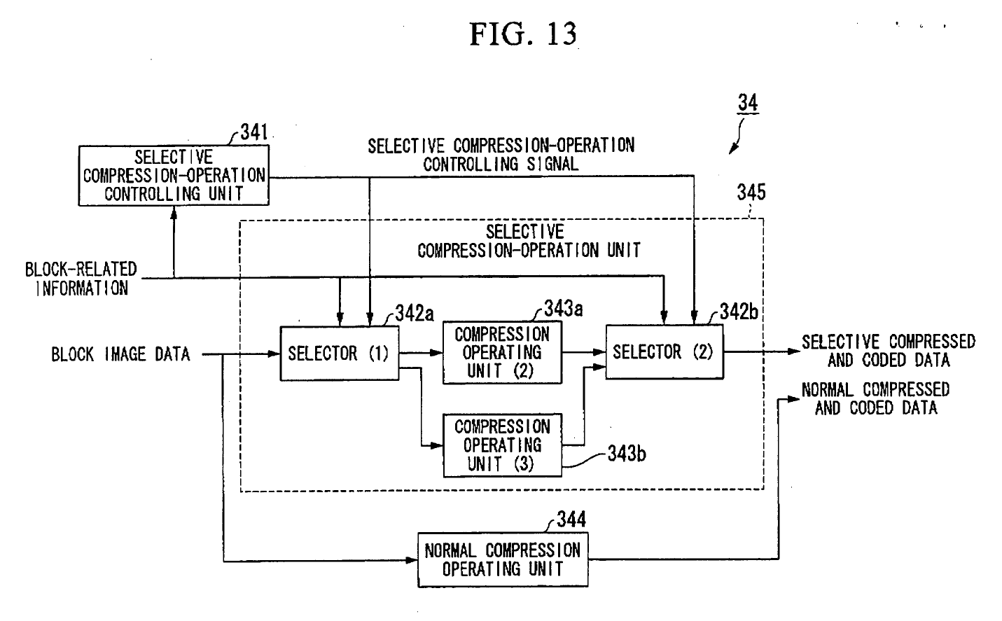

FIG. 13 is a block diagram illustrating a configuration of the compressing and coding unit 34 included in the coding unit 3 shown in FIG. 2. The compressing and coding unit 34 may include, but is not limited to, a selective compression-operation controlling unit 341, a normal compression operating unit 344, and a selective compression operating unit 345. The selective compression operating unit 345 may further include, but is not limited to, a selector (1) 342a, a selector (2) 342b, a compression operating unit (2) 343a, and a compression operating unit (3) 343b.

The selective compression-operation controlling unit 341 is functionally coupled to the block-dividing unit 33 shown in FIG. 2 to receive the set of block-related information from the block-dividing unit 33. The selective compression-operation controlling unit 341 is configured to generate a selective compression-operation controlling signal that controls operations of the selective compression operating unit 345, based on the set of input block-related information.

The normal compression operating unit 344 is functionally coupled to the block-dividing unit 33 shown in FIG. 2 to receive the set of block image data from the block-dividing unit 33. The normal compression operating unit 344 is configured to compress the set of block image data for all image blocks in accordance with a uniform compression characteristic, thereby generating a set of normal compressed and coded data. The uniform compression characteristic is independent from the image blocks. The uniform compression characteristic is applied to all of the image blocks. For example, the compression characteristic adapted to the first block 1 is applied to the second and third blocks 2 and 3.

The selective compression operating unit 345 is functionally coupled to the block-dividing unit 33 shown in FIG. 2 to receive the set of block-related information and the set of block image data from the block-dividing unit 33. The selective compression operating unit 345 is functionally coupled to the selective compression operation controlling unit 341 to receive the selective compression operation controlling signal from the selective compression-operation controlling unit 341. The selective compression operating unit 345 is configured to perform selective compressing and coding operations of the set of block image data, based on the set of block-related information and the selective compression-operation controlling signal. Input of the set of block image data that belongs to the second or third block 2 or 3 causes the selective compression-operation controlling signal to be activated, thereby allowing the selective compression operating unit 345 to operate. Input of the set of block image data belonging to the first block 1 causes the selective compression-operation controlling signal to be inactivated, thereby inhibiting operations of the selective compression operating unit 345.

The selector (1) 342a is functionally coupled to the block-dividing unit 33 shown in FIG. 2 to receive the set of block-related information and the set of block image data from the block-dividing unit 33. The selector (1) 342a is also functionally coupled to the selective compression-operation controlling unit 341 to receive the selective compression-operation controlling signal from the selective compression-operation controlling unit 341. If the selective compression-operation controlling signal is in the activated state, then the selector (1) 342a selects the compression operating unit (2) 343a or the compression operating unit (3) 343b, based on the set of block-related information. The selector (1) 342a supplies the set of block-related information and the set of block image data to a selected one of the compression operating unit (2) 343a and the compression operating unit (3) 343b.

The compression operating unit (2) 343a is functionally coupled to the selector (1) 342a to receive, if selected by the selector (1) 342a, the set of block-related information and the set of block image data from the selector (1) 342a. The compression operating unit (2) 343a is configured to apply the compressing and coding operations to the set of block image data, thereby generating a first set of selective compressed and coded data. The compressing and coding operations are performed based on the activated state of the selective compression-operation controlling signal.

The compression operating unit (3) 343b is functionally coupled to the selector (1) 342a to receive, if selected by the selector (1) 342a, the set of block-related information and the set of block image data from the selector (1) 342a. The compression operating unit (3) 343b is configured to apply the compressing and coding operations to the set of block image data, thereby generating a second set of selective compressed and coded data. The compressing and coding operations are performed based on the activated state of the selective compression-operation controlling signal.

The selector (2) 342b is functionally coupled to the compression operating unit (2) 343a to receive the first set of selective compressed and coded data from the compression operating unit (2) 343a. The selector (2) 342b is functionally coupled to the compression operating unit (3) 343b to receive the second set of selective compressed and coded data from the compression operating unit (3) 343b. The selector (2) 342b is functionally coupled to the selective compression-operation controlling unit 341 to receive the selective compression-operation controlling signal from the selective compression-operation controlling unit 341. The selector (2) 342b is functionally coupled to the block-dividing unit 33 shown in FIG. 2 to receive the set of block-related information from the block-dividing unit 33. The selector (2) 342b is configured to select the first set of selective compressed and coded data or the second set of selective compressed and coded data, based on the activated state of the selective compression-operation controlling signal and the set of block-related information. The selector (2) 342b is configured to output, as a set of selective compressed and coded data, a selected one of the first set of selective compressed and coded data or the second set of selective compressed and coded data.

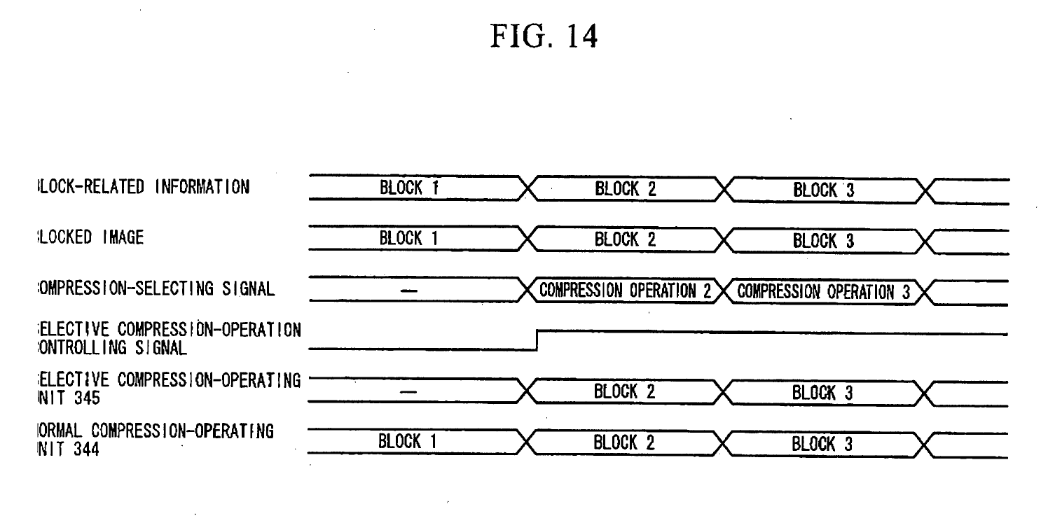

FIG. 14 is a timing chart illustrating waveforms of the block-related information signal, the block image data, the compression-selecting signal, the selective compression-operation controlling signal, a first block-selecting signal input to the selective compression operating unit 345, and a second block-selecting signal input to the selective compression-operation controlling unit 341. Operations of the compressing and coding unit 34 will be described with reference to FIGS. 13 and 14.

The block-related information signal is input into the compressing and coding unit 34. The block-related information signal is transmitted through the selector (1) 342a to the selected one of the compression operating unit (2) 343a and the compression operating unit (3) 343b as a block selecting signal. The set of block image data is input into the selective compression operating unit 345 and the normal compression operating unit 344. The selective compression-operation controlling signal that controls operations of the selective compression operating unit 345 is generated by the selective compression-operation controlling unit 341 based on the set of input block-related information.

The set of block image data is compressed by the normal compression operating unit 344 for all image blocks in accordance with the uniform compression characteristic, whereby a set of normal compressed and coded data is generated. The uniform compression characteristic is independent from the image blocks. The uniform compression characteristic is applied to all of the image blocks. For example, the compression characteristic adapted to the first block 1 is applied to the second and third blocks 2 and 3.

The selective compression operating unit 345 is controlled by the selective compression-operation controlling signal, which includes the selector (1) 342a, the selector (2) 342b, the compression operating unit (2) 343a, and the compression operating unit (3) 343b. If the set of input block image data belongs to the second or third block 2 or 3, then the selective compression-operation controlling signal is activated, thereby allowing the selective compression operating unit 345 to operate. The set of block-related information is input into the selector (1) 342a and the selector (2) 342b.

One of the compression operating unit (2) 343a, and the compression operating unit (3) 343b is selected to perform the compressing and coding operations.

The set of block image data belonging to the second block 2 is compressed and coded by the compression operating unit (2) 343a. The set of block image data belonging to the third block 3 is compressed and coded by the compression operating unit (3) 343b. If the set of input block image data belongs to the second block 2, then selector (1) 342a selects the compression operating unit (2) 343a and sends the set of block image data to the selected compression operating unit (2) 343a so that the set of block image data is compressed and coded by the selected compression operating unit (2) 343a. The selector (2) 342b selects the compression operating unit (2) 343a to receive the first set of compressed and coded data from the compression operating unit (2) 343a and output the first set of compressed and coded data as the selective compressed and coded data. If the set of input block image data belongs to the third block 3, then selector (1) 342a selects the compression operating unit (3) 343b and sends the set of block image data to the selected compression operating unit (3) 343b so that the set of block image data is compressed and coded by the selected compression operating unit (3) 343b. The selector (2) 342b selects the compression operating unit (3) 343b to receive the second set of compressed and coded data from the compression operating unit (3) 343b and output the second set of compressed and coded data as the selective compressed and coded data.

If the set of input block image data belongs to the first block 1, then the selective compression-operation controlling signal is inactivated, whereby the selective compression operating unit 345 is inhibited to operate.

For each of the image blocks, a suitable one of the plural compression operating units is selected to compress and code each of the image blocks. Combined operations of the selective compression-operation controlling unit 341, the selector (i) 342a, and the selector (2) 342b select one of the plural compression operating units in accordance with the result of determining the amount of distortion. Those configurations constitute the selecting unit and the compressing and coding unit.

The operations of the decoding unit 5 in decompression operations will be described. The configuration of the decoding unit 6 has been described with reference to FIG. 6. The set of block-related information, the set of normal compressed and coded data, the set of selective compressed and coded data are stored in the storing unit 4. The set of block-related information, the set of normal compressed and coded data, the set of selective compressed and coded data are read out of the storing unit 4 and then input into the decompressing unit 51 of the decoding unit 5.

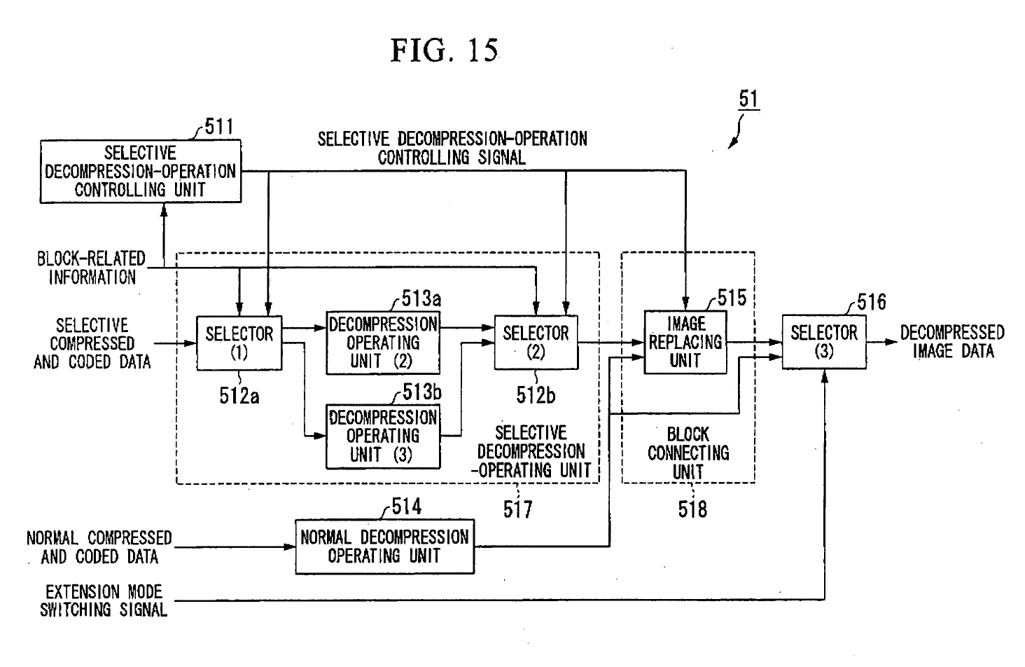

FIG. 15 is a block diagram illustrating a configuration of the decompressing unit 51 that is included in the decoding unit 5 shown in FIG. 6. The decompressing unit 51 may include, but is not limited to, a selective decompression operation controlling unit 511, a normal decompression operating unit 514, a selector (3) 516, a selective decompression operating unit 517, and a block connecting unit 518. The selective decompression operating unit 517 may further include, but is not limited to, a selector (1) 512a, a selector (2) 512b, a decompression operating unit (2) 513a and a decompression operating unit (3) 513b. The block connecting unit 518 may further include, but is not limited to, an image replacing unit 515.

The selective decompression operation controlling unit 511 is functionally coupled to the storing unit 4 that is shown in FIG. 1 to receive the set of block-related information from the storing unit 4. The selective decompression operation controlling unit 511 is configured to generate a selective decompression-operation controlling signal based on the set of block-related information. The selective decompression-operation controlling signal controls the selective decompression operating unit 517 and the block connecting unit 518.

The selective decompression operating unit 517 is functionally coupled to the storing unit 4 that is shown in FIG. 1 to receive the set of block-related information and the set of selective compressed and coded data from the storing unit 4. The selective decompression operating unit 517 is also functionally coupled to the selective decompression operation controlling unit 511 to receive the selective decompression-operation controlling signal from the selective decompression operation controlling unit 511. The selective decompression operating unit 517 is configured to apply a selective decompression operation to the set of selective compressed and coded data, based on the set of block-related information and the selective decompression-operation controlling signal, thereby generating a set of selective decompressed data. The activated state of the selective decompression-operation controlling signal allows the selective decompression operating unit 517 to operate. The inactivated state of the selective decompression-operation controlling signal inhibits the selective decompression operating unit 517 from operating.

The normal decompression operating unit 514 is functionally coupled to the storing unit 4 that is shown in FIG. 1 to receive the set of normal compressed and coded data from the storing unit 4. The normal decompression operating unit 514 is configured to apply a normal decompression operation to the set of normal compressed and coded data, thereby generating a set of normal decompressed data.

The block connecting unit 518 is functionally coupled to the selective decompression operation controlling unit 511 to receive the selective decompression-operation controlling signal from the selective decompression operation controlling unit 511, The activated state of the selective decompression-operation controlling signal allows the block connecting unit 518 to operate. The inactivated state of the selective decompression-operation controlling signal inhibits the block connecting unit 518 from operating. The block connecting unit 518 is functionally coupled to the selective decompression operating unit 517 to receive the set of selective decompressed data from the selective decompression operating unit 517. The block connecting unit 518 is also functionally coupled to the normal decompression operating unit 514 to receive the set of normal decompressed data from the normal decompression operating unit 514. The block connecting unit 518 is configured to connect or combine first, second and third sets of decompressed data that have been generated for the first, second and third blocks 1, 2, and 3, respectively, thereby generating a set of decompressed image data for a combined image. In the connection or combination of the first, second and third sets of decompressed data, parts of the set of normal decompressed data for the areas of the second and third blocks 2 and 3 are replaced by the sets of selective decompressed data for the areas of the second and third blocks 2 and 3. For example, the block connecting unit 518 is configured to take the set of normal decompressed data for the whole image area, and each set of selective decompressed data for each of the second and third blocks 2 and 3, and replace partially the set of normal decompressed data with the sets of the selective decompressed data for the areas of the second and third blocks 2 and 3. In other words, the block connecting unit 518 is configured to leave the set of normal decompressed data for the area of the first block 1, while replacing the set of normal decompressed data by the set of selective decompressed data for each of the areas of the second and third blocks 2 and 3, thereby generating a set of partially replaced decompressed data.

The selector (3) 516 is functionally coupled to the block connecting unit 518 to receive the et of partially replaced decompressed data from the block connecting unit 518. The selector (3) 516 is functionally coupled to the normal decompression operating unit 514 to receive the set of normal decompressed data from the normal decompression operating unit 514. The selector (3) 516 is configured to receive a decompression mode switching signal. The selector (3) 516 is configured to select one of the set of partially replaced decompressed data or the set of normal decompressed data, based on the decompression mode switching signal. If the decompression mode switching signal designates a normal decompression mode, then the selector (3) 516 selects the set of normal decompressed data and outputs the same as a set of decompressed image data. If the decompression mode switching signal designates a selective decompression mode, then the selector (3) 516 selects the set of partially replaced decompressed data and outputs the same as a set of decompressed image data.

The selector (1) 512a is functionally coupled to the storing unit 4 that is shown in FIG. 1 to receive the set of block-related information and the set of selective compressed and coded data from the storing unit 4. The selector (1) 512a is also functionally coupled to the selective decompression operation controlling unit 511 to receive the selective decompression-operation controlling signal from the selective decompression operation controlling unit 511. The selector (1) 512a is configured to select the decompression operating unit (2) 513a or the decompression operating unit (3) 513b based on the set of block-related information, wherein the selection is made based on the activated state of the selective decompression-operation controlling signal. The selector (1) 512a is configured to supply the set of selective compressed and coded data and the selective decompression-operation controlling signal to a selected one of the decompression operating unit (2) 513a and the decompression operating unit (3) 513b.

The decompression operating unit (2) 513a is functionally coupled to the selector (1) 512a to receive the set of selective compressed and coded data and the selective decompression-operation controlling signal from the selector (1) 512a if the decompression operating unit (2) 513a is selected by the selector (1) 512a. The decompression operating unit (2) 513a is configured to apply a decompression operation to the set of selective compressed and coded data that belongs to the second block 2, thereby generating a first set of selective decompressed data. The decompression operation is made based on the activated state of the selective decompression-operation controlling signal.

The decompression operating unit (3) 513b is functionally coupled to the selector (1) 512a to receive the set of selective compressed and coded data and the selective decompression-operation controlling signal from the selector (1) 512a if the decompression operating unit (3) 513b is selected by the selector (1) 512a. The decompression operating unit (3) 513b is configured to apply a decompression operation to the set of selective compressed and coded data that belongs to the third block 3, thereby generating a second set of selective decompressed data. The decompression operation is made based on the activated state of the selective decompression-operation controlling signal.

The selector (2) 512b is functionally coupled to the decompression operating unit (2) 513a to receive the first set of selective decompressed data from the decompression operating unit (2) 513a. The selector (2) 512b is also functionally coupled to the decompression operating unit (3) 513b to receive the second set of selective decompressed data from the decompression operating unit (3) 513b. The selector (2) 512b is also functionally coupled to the selective decompression operation controlling unit 511 to receive the selective decompression-operation controlling signal from the selective decompression operation controlling unit 511. The selector (2) 512b is also functionally coupled to the storing unit 4 that is shown in FIG. 1 to receive the set of block-related information from the storing unit 4. The selector (2) 512b is configured to select the first set of selective decompressed data or the second set of selective decompressed data, based on the activated state of the selective decompression-operation controlling signal and the set of block-related information. The selector (2) 512b is configured to output a selected one of the first set of selective decompressed data and the second set of selective decompressed data as a set of selective decompressed data.

The image replacing unit 515 is functionally coupled to the selective decompression operation controlling unit 511 to receive the selective decompression-operation controlling signal from the selective decompression operation controlling unit 511. The activated state of the selective decompression-operation controlling signal allows the image replacing unit 515 to operate. The inactivated state of the selective decompression-operation controlling signal inhibits the image replacing unit 515 from operating. The image replacing unit 515 is functionally coupled to the selective decompression operating unit 517 to receive the set of selective decompressed data from the selective decompression operating unit 517. The image replacing unit 515 is also functionally coupled to the normal decompression operating unit 514 to receive the set of normal decompressed data from the normal decompression operating unit 514. The image replacing unit 515 is configured to connect or combine first, second and third sets of decompressed data that have been generated for the first, second and third blocks 1, 2, and 3, respectively, thereby generating a set of decompressed image data for a combined image. In the connection or combination of the first, second and third sets of decompressed data, parts of the set of normal decompressed data for the areas of the second and third blocks 2 and 3 are replaced by the sets of selective decompressed data for the areas of the second and third blocks 2 and 3. For example, the image replacing unit 515 is configured to take the set of normal decompressed data for the whole image area, and each set of selective decompressed data for each of the second and third blocks 2 and 3, and replace partially the set of normal decompressed data with the sets of the selective decompressed data for the areas of the second and third blocks 2 and 3. In other words, the image replacing unit 515 is configured to leave the set of normal decompressed data for the area of the first block 1, while replacing the set of normal decompressed data by the set of selective decompressed data for each of the areas of the second and third blocks 2 arid 3, thereby generating a set of partially replaced decompressed data.

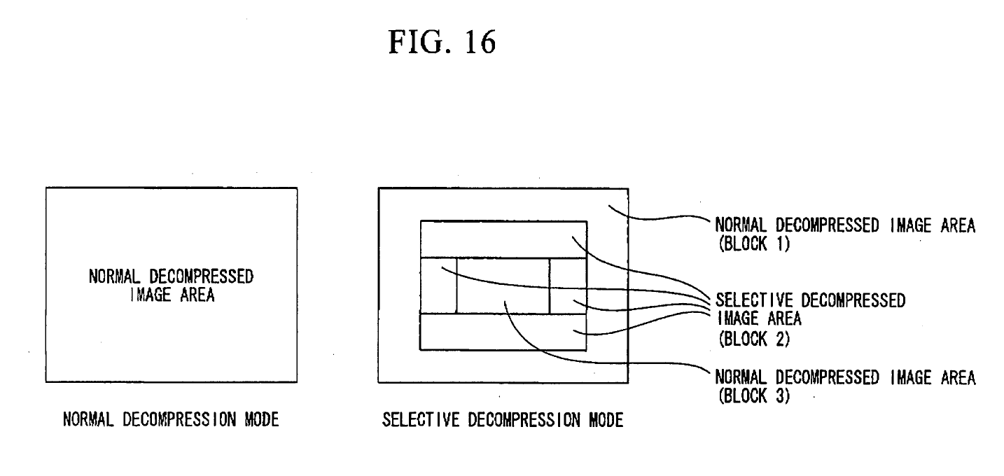

FIG. 16 is a view illustrating decompressed images generated by the decompressing unit 51 shown in FIG. 15 in the normal decompression mode and the selective decompression mode. In the normal decompression mode, the set of normal compressed and coded data for the entirety of an image is decompressed to generate the set of normal decompressed image data. In the selective decompression mode, for the first block 1, the set of normal compressed and coded data is decompressed by the normal decompression operating unit 514 to generate the set of normal decompressed image data. For each of the second and third blocks 2 and 3 other than the first block 1, the set of selective compressed and coded data is decompressed by the selective decompression operating unit 517 to generate the set of selective decompressed image data. The set of selective decompressed image data is selected by the image replacing unit 515. For the first block 1, the set of normal decompressed image data is selected by the image replacing unit 515.

Operations of the decompressing unit 51 will be described with reference to FIG. 15.

As described above, the set of compressed and coded data includes the set of selective compressed and coded data and the set of normal compressed and coded data The set of normal compressed and coded data is obtained by compressing the data of whole image by the normal compression operating unit 344 shown in FIG. 13. The set of normal compressed and coded data is input into the normal decompression operating unit 514. The set of selective compressed and coded data is obtained by compressing data for each of selected one or more blocks, for example, each of the second and third blocks 2 and 3. The plural sets of data for selected blocks such as the second and third blocks 2 and 3 are compressed by the different compression operating units (2)343a and (3)343b, respectively. The set of selective compressed and coded data is input into the normal decompression operating unit 517 that includes the selectors (1)512a and (2)512b and the decompression operating units (2)513a and (3)513b.

The selective decompression operation controlling unit 511 controls the selective decompression operating unit 517 and the block connecting unit 518 that includes the image replacing unit 515, based on the set of block-related information. For example, the selective decompression operation controlling unit 511 controls each of the selectors (1)512a and (2)512b in accordance with the selective decompression operation controlling signal based on the set of block-related information so as to select one of different decompression operations. The selected one of the different decompression operations corresponds to the selected one of the different compression operations for the compressing and coding operations. The selective decompression operation controlling signal is placed in the inactivated state while no set of selective compressed and coded data is input into the selective decompression operating unit 517. The selective decompression operation controlling unit 511 inhibits the selective decompression operating unit 517 from operating.

Upon receipt of the input of the set of selective compressed and coded data, the selective decompression operating unit 517 operates as follows. If the set of selective compressed and coded data belonging to the second block 2 is input into the selective decompression operating unit 517, then the selector (1) 512a selects the decompression operating unit (2) 513a to supply the set of selective compressed and coded data to the decompression operating unit (2) 513a. The decompression operating unit (2) 513a extends the set of selective compressed and coded data to generate the first set of selective decompressed data. The selector (2) 512b selects the decompression operating unit (2) 513a to receive the first set of selective decompressed data from the decompression operating unit (2) 513a. The selector (2) 512b outputs the first set of selective decompressed data.

If the set of selective compressed and coded data belonging to the third block 3 is input into the selective decompression operating unit 517, then the selector (1) 512a selects the decompression operating unit (3) 513b to supply the set of selective compressed and coded data to the decompression operating unit (3) 513b. The decompression operating unit (3) 513b extends the set of selective compressed and coded data to generate the second set of selective decompressed data. The selector (2) 512b selects the decompression operating unit (3) 513b to receive the second set of selective decompressed data from the decompression operating unit (3) 513b. The selector (2) 512b outputs the second set of selective decompressed data.

The first and second sets of selective decompressed data for the second and third blocks 2 and 3 are input into the block connecting unit 518 including the image replacing unit 515. The set of normal decompressed data for the first block 1 is also input into the block connecting unit 518 including the image replacing unit 515. The block connecting unit 518 connects the first and second sets of selective decompressed data for the second and third blocks 2 and 3 and the set of normal decompressed data for the first block 1, thereby generating a set of decompressed image data for whole image that includes the first, second and third blocks 1, 2 and 3.

The output from the block connecting unit 518 is connected to the selector (3) 516. The selector (3) 516 selects one of the normal decompression mode and the selective decompression mode based on the decompression mode switching signal. The normal decompression mode is to realize the simple decompression. The selective decompression mode is to realize the high quality decompression. As shown in FIG. 16, in the normal decompression mode, the set of normal compressed and coded data for the while image is decompressed to generate the set of normal decompressed data as the set of decompressed image data. In the selective decompression mode, the set of normal compressed and coded data for the first block 1 is subjected to the normal decompression operation, thereby generating the set of normal decompressed image data for the first block 1. The set of selective compressed and coded data for the second block 2 is subjected to the first selective decompression operation, thereby generating the first set of selective decompressed image data for the second block 2. The set of selective compressed and coded data for the third block 3 is subjected to the second selective decompression operation, thereby generating the second set of selective decompressed image data for the third block 3. The image replacing unit 515 replaces the sets of normal decompressed image data for the second and third blocks 2 and 3 by the first and second sets of selective decompressed image data for the second and third blocks 2 and 3, while leaving the set of normal decompressed data for the first block 1, thereby generating a set of partially replaced decompressed data as the set of decompressed image data.

As described above, co-operations of the selective decompression operation controlling unit 511 and the selectors (1) 512a and (2) 512b selects one of the plural decompression operating units, The selected one of the plural decompression operating units exhibits a decompression operation characteristic that corresponds to the compression operation characteristic of the compression operating unit that has performed the compressing and coding operations. This is one aspect of the embodiment of the decompressing and selecting units of the image processing system. As shown in FIG. 6, the set of decompressed image data is output from the decompressing unit 51 and then input into the display image processing unit 53.

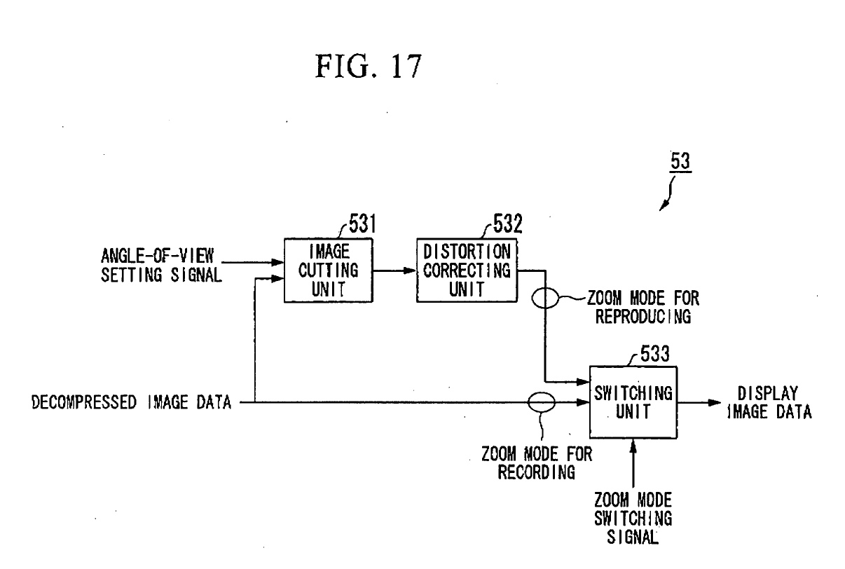

FIG. 17 is a block diagram illustrating a configuration of the display image processing unit 53 included in the decoding unit 5 shown in FIG. 6. The display image processing unit 53 may include, but is not limited to, an image cutting unit 531, a distortion correcting unit 532, and a switching unit 533.

The image cutting unit 531 is configured to receive an angle-of-view setting signal. The image cutting unit 531 is functionally coupled to the decompressing unit 51 shown in FIG. 6 to receive the set of decompressed image data from the decompressing unit 51. The image cutting unit 531 is configured to cut an image defined by the set of decompressed image data, based on the angle-of-view setting signal, thereby generating a set of cut image data.

The distortion correcting unit 532 is functionally coupled to the image cutting unit 531 to receive the set of cut image data from the image cutting unit 531. The distortion correcting unit 532 is configured to apply a distortion correction process and an enlargement process to the set of cut image data, thereby generating a set of distortion-corrected and enlarged image data.

The switching unit 533 is functionally coupled to the decompressing unit 51 shown in FIG. 6 to receive the set of decompressed image data from the decompressing unit 51. The switching unit 533 is also functionally coupled to the distortion correcting unit 532 to receive the set of distortion-corrected and enlarged image data from the distortion correcting unit 532. The switching unit 533 is configured to receive a zoom mode switching signal. The switching unit 533 is configured to select one of the set of decompressed image data and the set of distortion-corrected and enlarged image data, based on the zoom mode switching signal. The switching unit 533 is configured to output, as a set of display image data, the selected one of the set of decompressed image data and the set of distortion-corrected and enlarged image data. The zoom mode switching signal designates one of a reproducing zoom mode and a recording zoom mode In the reproducing zoom mode, the zooming process is performed by the display image processing unit 53 while reproducing the image data. In the recording zoom mode, the zooming process is performed by the cording unit 3 before storing the image data. If the zoom mode switching signal designates the recording zoom mode, then the switching unit 533 selects the set of decompressed image data and output the same as the set of display image data. If the zoom mode switching signal designates the reproducing zoom mode, then the switching unit 533 selects the set of distortion-corrected and enlarged image data and output the same as the set of display image data.

Operations of the display image processing unit 53 will be described with reference to FIG. 17. The set of decompressed image data is input into the image cutting unit 531. The set of decompressed image data is also input into the switching unit 533, The angle-of-view setting signal that has been set externally is input into the switching unit 533. If the zoom mode switching signal designates the recording zoom mode, then this means that the electronic zooming process and the distortion correction process have already been performed by the coding unit 3. Thus, in this case, the switching unit 533 selects the set of decompressed image data and output the same as the set of display image data.

If the zoom mode switching signal designates the reproducing zoom mode, this means that the electronic zooming process and the distortion correction process have not yet been performed. Thus, the electronic zooming process and the distortion correction process will be performed by the display image processing unit 53. For example, the angle-of-view setting signal is input into the image cutting unit 531. In a case, the angle-of-view setting signal may indicate a predetermined angle-of-view at which the image has been captured by the imager 2. In another case, the angle-of-view setting signal may indicate an optional angle-of-view that has been set by a user. The image defined by the set of decompressed image data is cut by the image cutting unit 531 based on the angle-of-view setting signal. The distortion correction process and the enlargement process is applied to the set of cut image data by the distortion correcting unit 532. The set of distortion-corrected and enlarged image data is input into the switching unit 533. The set of distortion-corrected and enlarged image data is selected by the switching unit 533 to be output as the set of display image data from the display image processing unit 53.

One of the plural compression operating units is selected so that the selected one corresponds to the amount of distortion of the optical system. The selected compression operating unit performs the compressing and coding operations of the set of image data. This configuration is suitable to perform the compressing and coding operations without causing a substantive deterioration of the quality of image and a remarkable increase of the amount of image data Namely, the image captured by the optical system having the optical distortion can be compressed and coded without causing a substantive deterioration of the quality of image.

One of the plural compression operations can be selected for each block thereby realizing simple and high speed compressing and coding operations of the set of image data. The optical-distortion-containing image is divided into a plurality of blocks, so that an optimum one of the plural compression operations can be selected for each block. This configuration can realize the compression and decompression operations that are optimized in the data size and the quality of image.

In accordance with the recording and reproducing system as the image processing system, the set of selective compressed and coded data is decompressed and decoded to generate a first set of decompressed image data, and the set of normal compressed and coded data is decompressed and decoded to generate a second set of decompressed image data. Parts of the second set of decompressed image data that correspond to the second and third blocks 2 and 3 are replaced with parts of the first set of decompressed image data that correspond to the second and third blocks 2 and 3, thereby generating a third set of decompressed image data. The second set of decompressed image data is lower in image quality than the third set of decompressed image data. The second set of decompressed image data can shorten the time needed to process the image and can generate simple image. The third set of decompressed image data can produce the high quality image. The image processing system is capable of generating the decompressed image data, if any.

Modifications:

A possible modification of the first embodiment will be described. In accordance with the above-described first embodiment, the selective compressing and coding operations for high quality image is performed while the normal compressing and coding operations for simple image is performed, before the set of selective compressed and coded data is decompressed to generate the set of selective decompressed data while the set of the normal compressed and coded data is decompressed to generate the set of normal decompressed data. The set of selective decompressed data or the set of normal decompressed data is selected optionally. For example, as shown in FIG. 15, the set of selective compressed and coded data and the set of normal compressed and coded data are input into the decoding unit 5 so that the set of selective compressed and coded data is decompressed to generate the set of selective decompressed data and the set of normal compressed and coded data is decompressed to generate the set of normal decompressed data. One of the set of selective decompressed data and the set of normal decompressed data is selected by the selector based on the decompression mode switching signal.

Instead of the high speed image display process, the image processing system can be adapted to further curtail the amount of compressed and coded data to be stored in the storing unit 4.

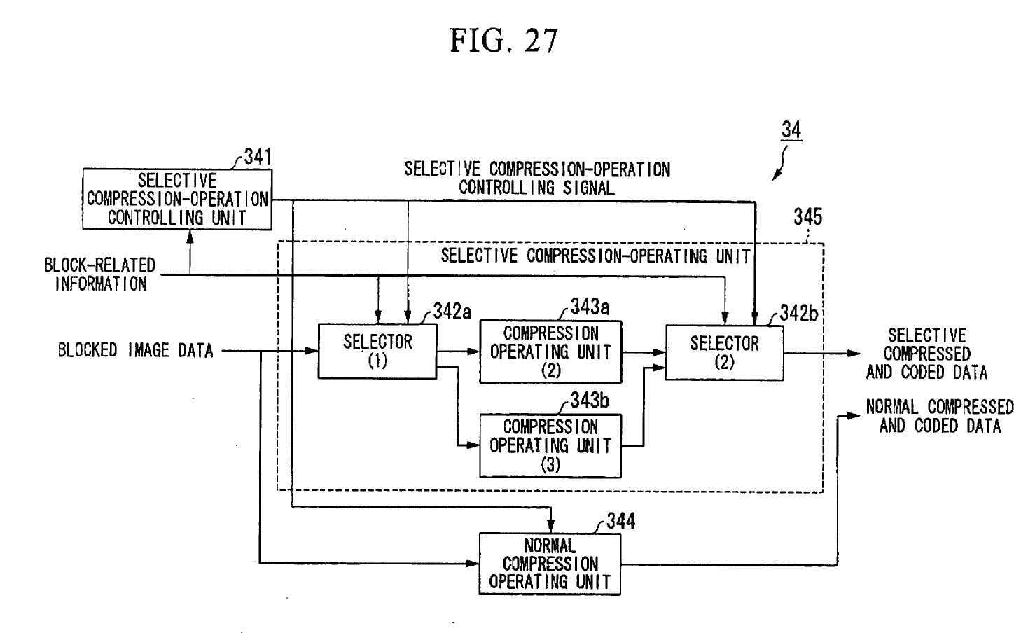

FIG. 27 is a block diagram illustrating a configuration of a modified compressing and coding unit 34 included in the coding unit 3 shown in FIG. 2. The compressing and coding unit 34 may include, but is not limited to, a selective compression-operation controlling unit 341, a normal compression operating unit 344, and a selective compression operating unit 345. The selective compression operating unit 345 may further include, but is not limited to, a selector (1) 342a, a selector (2) 342b, a compression operating unit (2) 343a, and a compression operating unit (3) 343b. The configuration of the compressing and coding unit 34 shown in FIG. 27 is different from the configuration of the compressing and coding unit 34 shown in FIG. 13 in view that the selective compression operation controlling signal is input into not only the selective compression operating unit 345 but also the normal compression operating unit 344. Input of the selective compression operation controlling signal into the normal compression operating unit 344 causes the normal compression operating unit 344 to perform a limited normal compression operation for the area of the first block 1 only, thereby generating a set of limited normal compressed and coded data of the area of the first block only. In other words, the selective compression operation controlling signal controls the normal compression operating unit 344 so that the normal compression operating unit 344 performs the limited normal compression operation for the area of the first block 1 only, thereby generating the set of limited normal compressed and coded data of the area of the first block only. The selective compression operation controlling signal also controls the selective compression operating unit 345 so that the selective compression operating unit 345 performs the selective compression operations for the areas of the second and third blocks 2 and 3, thereby generating the first set of selective compressed and coded data of the area of the second block 2 and the second set of selective compressed and coded data of the area of the third block 3.

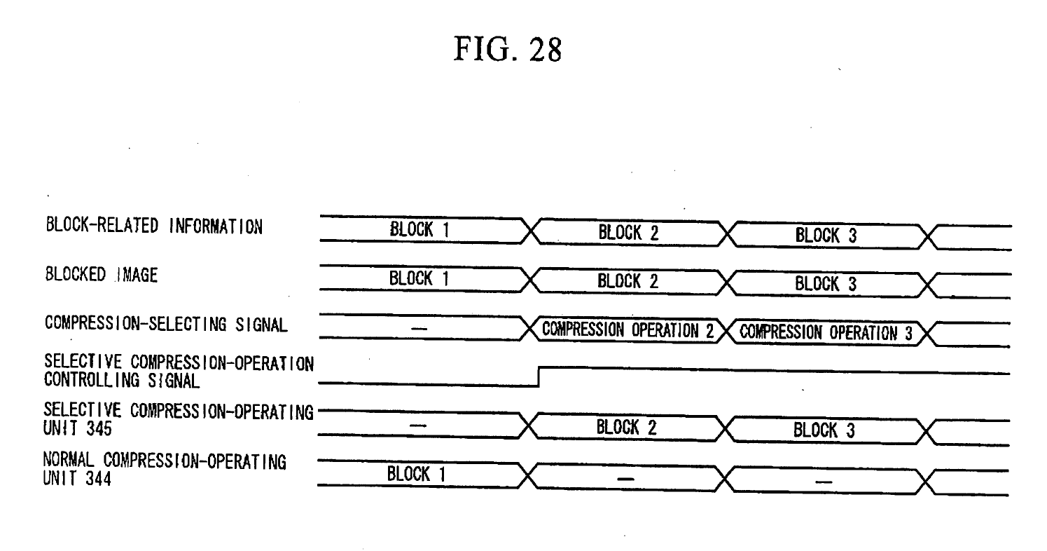

FIG. 28 is a timing chart illustrating waveforms of the block-related information signal, the block image data, the compression-selecting signal, the selective compression-operation controlling signal, a first block-selecting signal input to the selective compression operating unit 345, and a second block-selecting signal input to the selective compression-operation controlling unit 341. Operations of the compressing and coding unit 34 will be described with reference to FIGS. 27 and 28.

If the set of block-related information designates the first block 1, then the selective compression operation controlling signal controls the normal compression operating unit 344 so that the normal compression operating unit 344 performs the limited normal compression operation for the area of the first block 1 only, thereby generating the set of limited normal compressed and coded data of the area of the first block only.

If the set of block-related information designates the second block 2, then the selective compression operation controlling signal controls the selective compression operating unit 345 so that the selectors (2) 342a and (3) 342b select the compression operating unit (2) 343a. The selected compression operating unit (2) 343a performs the selective compressing and coding operation of the area of the second block 2, thereby generating the first set of selective compressed and coded data of the area of the second block 2.

If the set of block-related information designates the third block 3, then the elective compression operation controlling signal controls the selective compression operating unit 345 so that the selectors (2) 342a and (3) 342b select the compression operating unit (3) 343b. The selected compression operating unit (3) 343b performs the selective compressing and coding operation of the area of the third block 3, thereby generating the second set of selective compressed and coded data of the area of the third block 3.

The decompressing unit 51 included in the decoding unit 5 shown in FIG. 6 may include the same elements as described above with reference to FIG. 15. The decompressing unit 51 is adapted to keep the selector (3) 516 in selecting the output from the image replacing unit 515, so that the high quality image only is output as the decompressed image. The image replacing unit 515 is configured not to perform the above-described replacement process. The image replacing unit 515 is configured to perform combine or connect the first and second sets of selective decompressed image data and the set of normal decompressed image data. This modified configuration allows a further curtailment or reduction in the amount of compressed and coded data to be stored in the storing unit 4.

A further modification in the configuration of the compressing and coding unit 34 shown in FIG. 27 can be made. The selectors (1) 342a and (2) 342b can be configured to select one of the compression operating unit (2) 343a, the compression operating unit (3) 343b, and the normal compression operating unit 344.

If the set of block-related information designates the first block 1, then the selector (1) 342a selects the normal compression operating unit 344. The normal compression operating unit 344 applies the normal compressing and coding operations to the set of input blocked image data, thereby generating a set of normal compressed and coded data. The selector (2) 342b outputs the set of normal compressed and coded data as a first output from the compressing and coding unit 34.

If the set of block-related information designates the second block 2, then the selector (1) 342a selects the compression operating unit (2) 343a. The compression operating unit (2) 343a applies the selective compressing and coding operations to the set of input blocked image data, thereby generating a first set of selective compressed and coded data. The selector (2) 342b outputs the first set of selective compressed and coded data as the second output from the compressing and coding unit 34.

If the set of block-related information designates the third block 3, then the selector (1) 342a selects the compression operating unit (3) 343b. The compression operating unit (3) 343b applies the selective compressing and coding operations to the set of input blocked image data, thereby generating a second set of selective compressed and coded data. The selector (2) 342b outputs the second set of selective compressed and coded data as the third output from the compressing and coding unit 34.

In this case, the configuration of the decompressing unit 51 shown in FIG. 15 can be modified. The selectors (1) 512a and (2) 512b select one of the decompression operating unit (2) 513a, the decompression operating unit (3) 513b, and the normal decompression operating unit 514.

If the set of block-related information designates the first block 1, then the selector (1) 512a selects the normal decompression operating unit 514. The normal decompression operating unit 514 applies the normal decompression operation to the set of normal compressed and coded data as the first output from the compressing and coding unit 34, thereby generating a set of normal decompressed data. The selector (2) 512b supplies the set of normal decompressed data to the image replacing unit 515 included in the block connecting unit 518.

If the set of block-related information designates the second block 2, then the selector (1) 512a selects the decompression operating unit (2) 513a. The decompression operating unit (2) 513a applies the selective decompression operation to the first set of selective compressed and coded data as the second output from the compressing and coding unit 34, thereby generating a first set of selective decompressed data. The selector (2) 512b supplies the first set of selective decompressed data to the image replacing unit 515 included in the block connecting unit 518.

If the set of block-related information designates the third block 3, then the selector (1) 512a selects the decompression operating unit (3) 513b. The decompression operating unit (3) 513b applies the selective decompression operation to the second set of selective compressed and coded data as the third output from the compressing and coding unit 34, thereby generating a second set of selective decompressed data. The selector (2) 512b supplies the second set of selective decompressed data to the image replacing unit 515 included in the block connecting unit 518.

The image replacing unit 515 connects or combines the set of normal decompressed data for the first block 1, the first set of selective decompressed data for the second block 2, and the second set of selective decompressed data for the third block 3.

The selector (3) 516 is configured to always select the output from the image replacing unit 515 and not select the output from the normal decompression operating unit 514. The selector (3) 516 can be omitted. The output from the image replacing unit 515 can be supplied directly to the image display unit 6.

Second Embodiment:

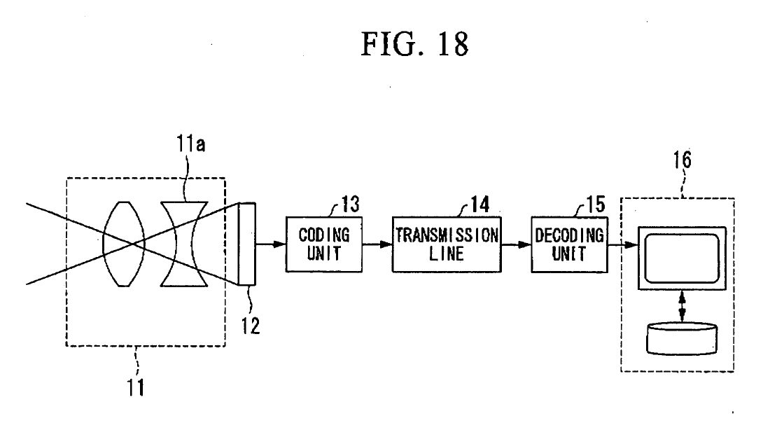

A second embodiment of the present invention will be described. FIG. 18 is a block diagram illustrating a configuration of an image processing system as a remote monitoring system that utilizes an image coding apparatus in accordance with a second embodiment of the present invention. The remote monitoring system has the following configuration. The remote monitoring system may include, but is not limited to, an optical system 11 having a distortion-containing optical element 11a, an imager 12 as an image pickup device, a coding unit 13, a transmission line 14, a decoding unit 15, and an image storing and displaying unit 16. The optical system 11 having the distortion containing optical element 11a, and the imager 12 are similar to the optical system 1 having the distortion containing optical element 1a, and the imager 2 shown in FIG. 1. Descriptions of those elements will be omitted.

The coding unit 13 performs as an image coding apparatus. The coding unit 13 is configured to receive the set of image data from the imager 12. The coding unit 13 is configured to perform a variety of image processing to the received set of image data The coding unit 13 is configured to compress and code the set of image data thereby generating a set of compressed and coded image data.

The transmission line 14 may be a wired or wireless communication path that is adapted to transmit compressed and coded image data.

The decoding unit 15 is configured to receive the set of compressed and coded data transmitted on the transmission line 14. The decoding unit 15 is configured to decode the set of compressed and coded data. The decoding unit 15 is configured to perform a variety of image processing.

The image display unit 16 is configured to receive the set of decoded image data from the decoding unit 15. The image display unit 16 is configured to store the received set of decoded image data and display an image based on the received set of decoded image data.

The coding unit 13 and the decoding unit 15 are similar in schematic operations to the coding unit 3 and the decoding unit 5 shown in FIG. 1.

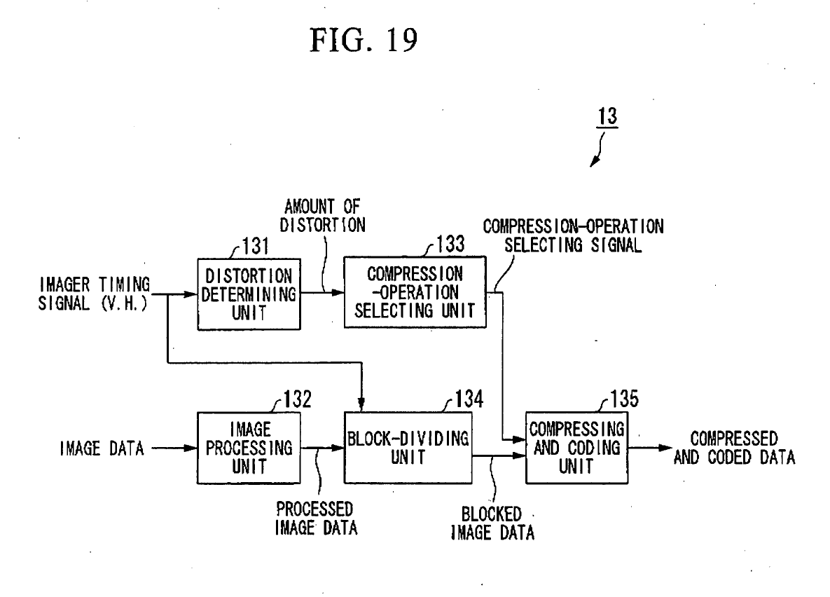

FIG. 19 is a block diagram illustrating a configuration of the coding unit 13 included in the remote monitoring system shown in FIG. 18. The coding unit 13 may include, but is not limited to, a distortion determining unit 131, an image processing unit 132, a compression operation selecting unit 133, a block-dividing unit 134, and a compressing and coding unit 135.

The image processing unit 132 is functionally coupled to the imager 12 to receive the set of electronic image data from the imager 12. The image processing unit 132 is configured to perform a predetermined set of image processes for the set of electronic image data, thereby generating a set of processed image data The distortion determining unit 131 is functionally coupled to the imager 12 to receive an imager timing signal (V.H.) from the imager 12. The distortion determining unit 131 is configured to determine the amount of optical distortion contained in an image that corresponds to the set of electronic image data and generate a distortion signal that represents the determined amount of optical distortion, wherein the determination is made based on the imager timing signal (V.H.). The distortion determining unit 131 is configured to determine the amount of optical distortion at coordinates of each block.

The compression operation selecting unit 133 is functionally coupled to the distortion determining unit 131 to receive the distortion signal from the distortion determining unit 131. The compression operation selecting unit 133 is configured to select an optimum one of plural different compression operations, based on the amount of distortion indicated by the distortion signal, thereby generating a compression operation selecting signal as a result of the selection.

The block-dividing unit 134 is functionally coupled to the imager 12 to receive he imager timing signal (V.H.) from the imager 12. The block-dividing unit 134 is also functionally coupled to the image processing unit 132 to receive the set of processed image data from the image processing unit 132. The block-dividing unit 134 is configured to divide the set of processed image data into a plurality of image blocks having predetermined sizes, thereby generating the plurality of image blocks. The dividing process is performed based on the imager timing signal (V.H.). The block-dividing unit 33 shown in FIG. 2 is configured to divide the set of processed image data into a plurality of image blocks that have sizes decided based on the distortion signal. In contrast, the block-dividing unit 134 is configured to divide the set of processed image data into a plurality of image blocks having predetermined sizes.

The compressing and coding unit 135 is functionally coupled to the block-dividing unit 134 to receive the plurality of image blocks from the block-dividing unit 33. The compressing and coding unit 135 is also functionally coupled to the compression operation selecting unit 133 to receive the compression operation selecting signal from the compression operation selecting unit 133. The compressing and coding unit 135 is configured to compress and code the plurality of image blocks, based on the compression operation selecting signal, thereby generating a set of compressed and coded data. The compressing and coding unit 135 includes a plurality of compression operating units that have different compressing and coding performances or different compressing performances from each other. For each block, one of the compression operating units is selected based on the distortion signal. The selected compression operating unit performs the compression operation, thereby generating a set of compressed and coded data for each block. The set of compressed and coded data is output from the compressing and coding unit 135 and transmitted to the transmission line 14 shown in FIG. 18.

Operations of the coding unit 13 will be described. In accordance with this embodiment, a set of image data includes a luminance data and a chrominance data The set of image data is input into the image processing unit 132. The image processing unit 132 performs a predetermined variety of image processing and an electronic zooming process and a distortion correcting process. The predetermined variety of image processing may be similar to that described in the first embodiment. The set of processed image data is input into the block-dividing unit 134. The block-dividing unit 134 divides the set of processed image data into a plurality of image blocks having predetermined sizes, differently from the block-dividing unit 33 of the first embodiment.

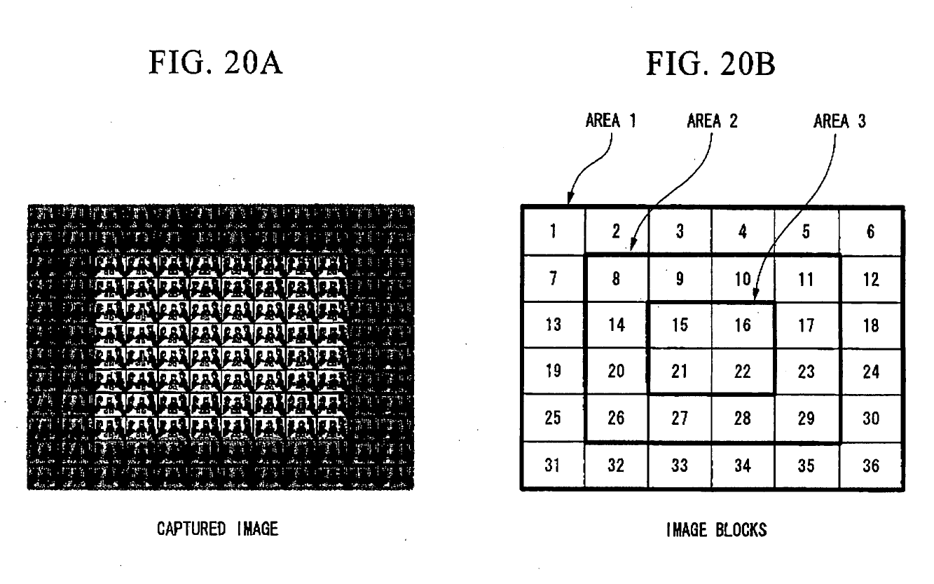

FIG. 20A is a view illustrating an image captured by the optical system 11 and the imager 12 shown in FIG. 18. FIG. 20B is a view illustrating an example of a plurality of blocks divided from the image of FIG. 20A by the block-dividing unit 134 shown in FIG. 19. In accordance with the above-described first embodiment, the block-dividing unit 33 shown in FIG. 2 divides the captured image into the three blocks. The size of each of the blocks is decided depending upon the amount of distortion of each of the blocks. In contrast, in accordance with the second embodiment, the captured image is divided into a plurality of blocks that have a predetermined size that is independent from the amount of distortion. For example, as shown in FIG. 20B, the captured image can be divided into first to thirty-sixth blocks 1-36 that are aligned in a matrix array of 6×6. The captured image can also be classified into three areas that depend on the amount of distortion. A first area 1 has a first class of the first to seventh blocks 1-7, the twelfth and thirteenth blocks 12 and 13, the eighteenth and nineteenth blocks 18 and 19, the twenty-fourth and twenty-fifth blocks 24 and 25, and the thirtieth to thirty-sixth blocks 30-36. A second area 2 has a second class of the eighth to eleventh blocks 8-11, the fourteenth block 14, the seventeenth block 17, the twentieth bock 20, the twenty-third block 23, and the twenty-sixth to twenty-ninth blocks 26-29. A third area 3 has a third class of the fifteenth and sixteenth blocks 15 and 16 and the twenty-first and twenty-second blocks 21 and 22. The compressing and coding processes are controlled depending upon each amount of distortion of each of the first to thirty-sixth blocks 1-36.

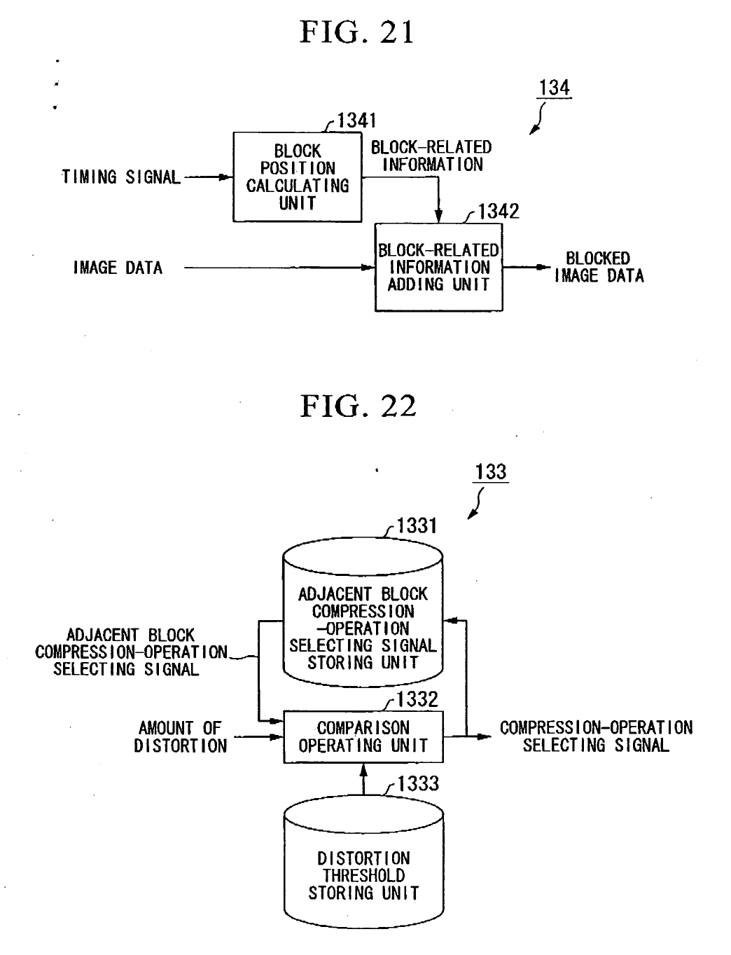

FIG. 21 is a block diagram illustrating a configuration of the block-dividing unit 134 included in the coding unit 13 shown in FIG. 19. The block-dividing unit 134 may include, but is not limited to, a block position calculating unit 1341 and a block-related information adding unit 1342. The block position calculating unit 1341 is functionally coupled to the imager 12 shown in FIG. 18 to receive the imager timing signal from the imager 12. The block position calculating unit 1341 is configured to calculate the position of a block that corresponds to the input set of processed image data, based on the imager timing signal, thereby generating a set of block-related information that indicates a block, to which the input set of processed image data belongs.

The block-related information adding unit 1342 is functionally coupled to the image processing unit 132 shown in FIG. 19 to receive the set of processed image data from the image processing unit 132. The block-related information adding unit 1342 is also functionally coupled to the block position calculating unit 1341 to receive the set of block-related information from the block position calculating unit 1341. The block-related information adding unit 1342 is configured to add a set of block-related information to the set of processed image data for each block, thereby generating a set of blocked image data for each block.

Operations of the block-dividing unit 134 will be described. In accordance with the present embodiment, the image is divided into a plurality of blocks that have a predetermined size. The set of block-related information is switched based on the imager timing signal from the imager 12. For example, the position of a block that corresponds to the input set of processed image data is calculated by the block position calculating unit 1341, based on the imager timing signal, thereby generating a set of block-related information that indicates a block, to which the input set of processed image data belongs. The set of block-related information is then input into the block-related information adding unit 1342. The set of block-related information is added to the set of processed image data for each block by the block-related information adding unit 1342, thereby generating a set of blocked image data for each block. The set of blocked image data is output from the block-related information adding unit 1342 for each block.

The distortion determining unit 131 shown in FIG. 19 determines the amount of optical distortion at coordinates of each block. Basic operations of the distortion determining unit 131 are similar to those of the distortion determining unit 31 that have been described in the first embodiment. The amount of distortion is output from the distortion determining unit 131 and then input into the compression operation selecting unit 133. The compression operation selecting unit 133 selects an optimum one, for each block, of plural different compression operations, based on the amount of distortion indicated by the distortion signal, thereby generating a compression operation selecting signal as a result of the selection. The compression operation selecting signal is output from the compression operation selecting unit 133 and then input into the compressing and coding unit 135.

FIG. 22 is a block diagram illustrating a configuration of the compression operation selecting unit 133 included in the coding unit 13 shown in FIG. 19. The compression operation selecting unit 133 may include, but is not limited to, an adjacent block compression operation selecting signal storing unit 1331 performing as a selecting result storing unit, a comparison operating unit 1332 performing as a selecting signal generating unit, and a distortion threshold storing unit 1333.

The adjacent block compression operation selecting signal storing unit 1331 is configured to store a comparison operation selecting signal for an adjacent block. The adjacent block is positioned adjacent to a current block. For the adjacent block, an optimum compression operation has been selected and input into the compressing and coding unit 135 shown in FIG. 19. The adjacent block is adjacent to a current block For the current block, an optimum compression operation is now being selected by the compression operation selecting unit 133. A large difference in the characteristics of the compression operation to be selected for the current block from that for the adjacent block may cause an undesired noise. In order to avoid the large difference, the characteristics of the adjacent block should be referred and taken into account in selecting an optimum compression operation for the current block.

The distortion threshold storing unit 1333 is configured to store plural distortion thresholds that are to be used for selecting, based on the amount of distortion, an optimum compression operation performed by the compressing and coding unit 135 shown in FIG. 19.

The comparison operating unit 1332 is functionally coupled to the adjacent block compression operation selecting signal storing unit 1331 to receive an adjacent block compression operation selecting signal from the adjacent block compression operation selecting signal storing unit 1331. The adjacent block compression operation selecting signal has been supplied to the compressing and coding unit 135 so that the compressing and coding unit 135 has selected an optimum compression operation for the adjacent block that is adjacent to the current block. The comparison operating unit 1332 is also functionally coupled to the distortion determining unit 131 shown in FIG. 19 to receive a distortion signal from the distortion determining unit 131. The comparison operating unit 1332 is also functionally coupled to the distortion threshold storing unit 1333 to receive the plural distortion thresholds from the distortion threshold storing unit 1333.

The comparison operating unit 1332 is configured to compare the input amount of distortion to the plural distortion thresholds. The comparison operating unit 1332 is configured to select, based on the comparison result, plural candidates for compression operations from the plurality of compression operations that are available by the compressing and coding unit 135 shown in FIG. 19. The comparison operating unit 1332 is configured to select an optimum compression operation for the current block from the selected plural candidates, thereby generating a compression operation selecting signal. The optimum compression operation being now selected for the current block has characteristics similar to those of a selected optimum compression operation that have been selected for the adjacent block. The optimum compression operation is indicated by the adjacent block compression operation selecting signal for the adjacent block. The optimum compression operation is selected by taking into account the amount of distortion.

If the characteristics of the optimum compression operation for the current block are similar to the characteristics of the selected optimum compression operation indicated by the adjacent block compression operation selecting signal for the adjacent block, then this means that the difference in characteristics between the candidates for the compression operation for the current block and the selected compression operation for the adjacent block is within an acceptable range or extent.

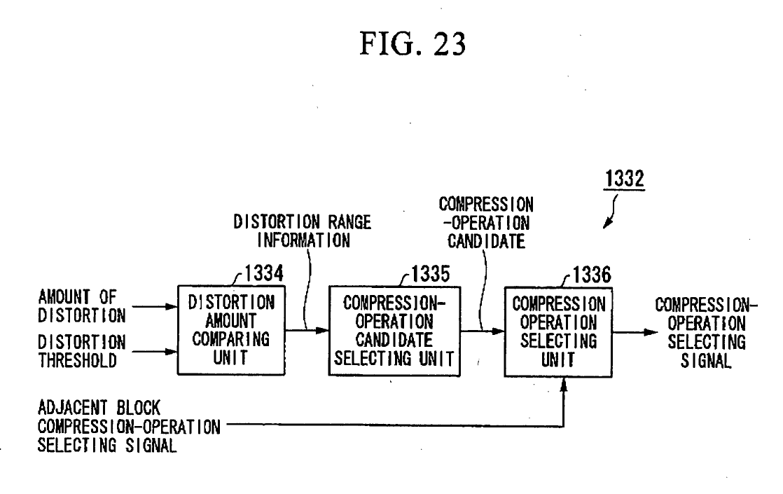

FIG. 23 is a block diagram illustrating a configuration of the comparison operating unit 1332 included in the compression operation selecting unit 133 shown in FIG. 22. The comparison operating unit 1332 may include, but is not limited to, a distortion amount comparing unit 1334, a comparison operation candidate selecting unit 1335, and a compression operation selecting unit 1336.

The distortion amount comparing unit 1334 is functionally coupled to the distortion determining unit 131 shown in FIG. 19 to receive the distortion signal indicating the amount of distortion from the distortion determining unit 131. The distortion amount comparing unit 1334 is functionally coupled to the distortion threshold storing unit 1333 to receive the plural distortion thresholds from the distortion threshold storing unit 1333. The distortion amount comparing unit 1334 is configured to compare the amount of distortion to the plural distortion thresholds so as to determine a distortion range that includes the amount of distortion, thereby generating a set of distortion range information. The distortion ranges are defined by the plural distortion thresholds.

The comparison operation candidate selecting unit 1335 is functionally coupled to the distortion amount comparing unit 1334 to receive the set of distortion range information from the distortion amount comparing unit 1334. The comparison operation candidate selecting unit 1335 is configured to select, based on the set of distortion range information, plural compression operation candidates for the current block, thereby generating a compression operation candidate signal that indicates the selected compression operation candidates. The selection is made from the plurality of compression operations that are available by the compressing and coding unit 135 shown in FIG. 19.

The compression operation selecting unit 1336 is functionally coupled to the comparison operation candidate selecting unit 1335 to receive the compression operation candidate signal from the compression operation selecting unit 1336. The compression operation selecting unit 1336 is functionally coupled to the adjacent block compression operation selecting signal storing unit 1331 to receive the adjacent block compression operation selecting signal from the adjacent block compression operation selecting signal storing unit 1331. The compression operation selecting unit 1336 selects an optimum compression operation for the current block from the selected plural compression operation candidates, thereby generating a compression operation selecting signal that indicates the optimum compression operation. The optimum compression operation being now selected for the current block has characteristics similar to those of a selected optimum compression operation that have been selected for the adjacent block. The selected optimum compression operation is indicated by the adjacent block compression operation selecting signal for the adjacent block. The optimum compression operation is selected by taking into account the amount of distortion.

Operations of the comparison operating unit 1332 will be described with reference to FIG. 23. The distortion signal indicating the amount of distortion is output from the distortion determining unit 131 and then input into the distortion amount comparing unit 1334. The plural distortion thresholds are output from the distortion threshold storing unit 1333 and input into the distortion amount comparing unit 1334. The amount of distortion is compared to the plural distortion thresholds by the distortion amount comparing unit 1334, so that the distortion range including the amount of distortion is determined by the distortion amount comparing unit 1334, whereby the set of distortion range information is generated. The set of distortion range information is output from the distortion amount comparing unit 1334 and input into the comparison operation candidate selecting unit 1335.

The plural compression operation candidates for the current block are selected by the comparison operation candidate selecting unit 1335, based on the set of distortion range information, thereby generating a compression operation candidate signal that indicates the selected compression operation candidates. The selection is made from the plurality of compression operations that are available by the compressing and coding unit 135 shown in FIG. 19. The compression operation candidate signal is output from the comparison operation candidate selecting unit 1335 and input into the compression operation selecting unit 1336. The optimum compression operation is selected by the compression operation selecting unit 1336 for the current block from the selected plural compression operation candidates, thereby generating a compression operation selecting signal that indicates the optimum compression operation. The compression operation selecting signal is output from the comparison operating unit 1332. The optimum compression operation being now selected for the current block has characteristics similar to those of a selected optimum compression operation that have been selected for the adjacent block. The selected optimum compression operation is indicated by the adjacent block compression operation selecting signal for the adjacent block. The optimum compression operation is selected by taking into account the amount of distortion.

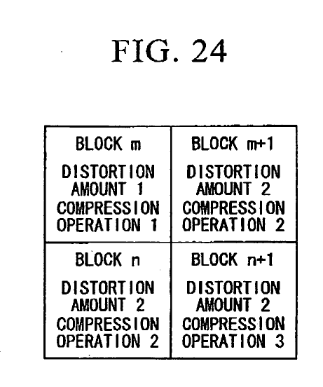

FIG. 24 is a view illustrating interrelationships among the block, the amount of distortion and the comparison operation selected by the compression operation selecting unit 1336 included in the comparison operating unit 1332 shown in FIG. 23. Operations of the compression operation selecting unit 1336 will be described with reference to FIG. 24. A block “m” has a distortion amount 1, while blocks “m+1”, “n”, and “n+1” have a distortion amount 2. For the block “m”, a compression operation 1 has been selected. It is assumed that compression operations 2, 3 and 4 are selected as the candidates for the distortion mount 2. The compression operation 2 is most similar in characteristics to the compression operation 1. The compression operation 4 is most different in characteristics from the compression operation 1. The compression operation 2 is optimum in view of the amount of distortion.

For the blocks “m+1” and “n” adjacent to the block “m”, the compression operation 3 is optimum. The compression operation 3 is not similar to the compression operation 1 that has been selected for the block “m”. Therefore, the compression operation 2 that has the similar characteristics to the compression operation 1 is selected for the blocks “m+1” and “n”. The block “n+1” is adjacent to the block “m+1” and also adjacent to the block “n”. For the blocks “m+1” and “n”, the compression operation 2 has been selected. In view of the amount distortion, the compression operation 3 is optimum for the block “n+1”. The compression operation 2 is similar to the compression operation 3. Thus, the compression operation 3 is selected for the block “n+1”.

As described above, the block “m” has been subjected to the compression operation 1. The block “m+1” has been subjected to the compression operation 2. The block “n” has been subjected to the compression operation 2. The block “n+1” has been subjected to the compression operation 3. The compression operation 1 is similar in characteristics to the compression operation 2. The compression operation 2 is similar in characteristics to the compression operation 3. Thus, the blocks “m” and “m+1” that are adjacent to each other are similar to each other in view of compression characteristics. The blocks “m” and “n” that are adjacent to each other are similar to each other in view of compression characteristics. The blocks “m+1” and “n+1” that are adjacent to each other are similar to each other in view of compression characteristics. The blocks “n” and “n+1” that are adjacent to each other are similar to each other in view of compression characteristics. The above selections of the compression operations reduce noises that are caused by the difference of the compression characteristics. The compression operation selecting unit 1336 selects each optimum compression operation for each block. The compression operation selecting unit 1336 generates a compression operation selecting signal that indicates the selected optimum compression operation for each block. The compression operation selecting signal is output from the compression operation selecting unit 1336 and input into the compressing and coding unit 135 shown in FIG. 19.

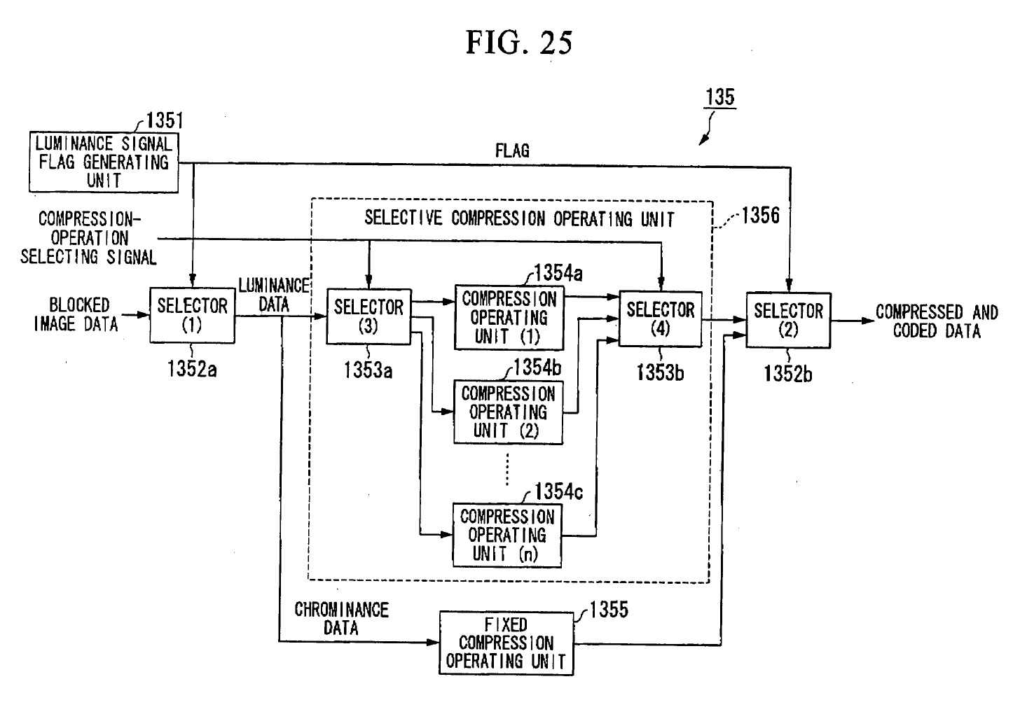

FIG. 25 is a block diagram illustrating a configuration of the compressing and coding unit 135 included in the coding unit 13 shown in FIG. 19. The compressing and coding unit 135 may include, but is not limited to, a luminance data flag generating unit 1351 as an image data type determining unit, a selector (1) 1352a, a selector (2) 1352b, a fixed compression operating unit 1355, and a selective compression operating unit 1356.

The luminance data flag generating unit 1351 is configured to generate a flag that corresponds to a type of image data. The flag indicates the type of the set of blocked image data input into the compressing and coding unit 135, for example, a luminance data or a chrominance data.

The selector (1) 1352a is functionally coupled to the block-dividing unit 134 shown in FIG. 19 to receive the set of blocked image data from the block-dividing unit 134. The selector (1) 1352a is functionally coupled to the luminance data flag generating unit 1351 to receive the flag from the luminance data flag generating unit 1351. If the flag indicates the luminance data for the set of input blocked image data, then the selector (1) 1352a selects the selective compression operating unit 1356 to supply the set of blocked image data as the luminance data to the selective compression operating unit 1356. If the flag indicates the chrominance data for the set of input blocked image data, then the selector (1) 1352a selects the fixed compression operating unit 1355 to supply the set of blocked image data as the chrominance data to the fixed compression operating unit 1355.

The fixed compression operating unit 1355 is functionally coupled to the selector (1) 1352a to receive the set of blocked image data as the chrominance data from the selector (1) 1352a, if the flag indicates the chrominance data for the set of input blocked image data. The fixed compression operating unit 1355 is configured to perform a fixed compression operation of the set of blocked image data as the chrominance data, thereby generating a first set of compressed and coded data as the chrominance data.

The selective compression operating unit 1356 is functionally coupled to the selector (1) 1352a to receive the set of blocked image data as the luminance data from the selector (1) 1352a, if the flag indicates the luminance data for the set of input blocked image data. The selective compression operating unit 1356 is functionally coupled to the compression operation selecting unit 133 shown in FIG. 19 to receive the compression operation selecting signal from the compression operation selecting unit 133. The selective compression operating unit 1356 is configured to perform a selective compression operation of the set of blocked image data as the luminance data, thereby generating a second set of compressed and coded data as the luminance data.

The selector (2) 1352b is functionally coupled to the luminance data flag generating unit 1351 to receive the flag from the luminance data flag generating unit 1351. If the flag indicates the luminance data for the set of input blocked image data, then the selector (2) 1352b selects the selective compression operating unit 1356 to receive the second set of compressed and coded data as the luminance data from the selective compression operating unit 1356. The selector (2) 1352b outputs the second set of compressed and coded data as the luminance data. If the flag indicates the chrominance data for the set of input blocked image data, then the selector (2) 1352b selects the fixed compression operating unit 1355 to receive the first set of compressed and coded data as the chrominance data from the fixed compression operating unit 1355. The selector (2) 1352b outputs the first set of compressed and coded data as the chrominance data.

The selective compression operating unit 1356 may further include, but is not limited to, a selector (3) 1353a, a selector (4) 1353b, a compression operating unit (1) 1354a, a compression operating unit (2) 1354b, and a compression operating unit (n) 1354c.

The selector (3) 1353a is functionally coupled to the selector (1) 1352a to receive the set of blocked image data as the luminance data from the selector (1) 1352a, if the flag indicates the luminance data for the set of input blocked image data. The selector (3) 1353a is functionally coupled to the compression operation selecting unit 133 shown in FIG. 19 to receive the compression operation selecting signal from the compression operation selecting unit 133. The selector (3) 1353a is configured to select one of the compression operating unit (1) 1354a, the compression operating unit (2) 1354b, and the compression operating unit (n) 1354c, based on the compression operation selecting signal, thereby supplying the set of blocked image data as the luminance data to a selected one of the compression operating unit (1) 1354a, the compression operating unit (2) 1354b, and the compression operating unit (n) 1354c.

Each of the compression operating unit (1) 1354a, the compression operating unit (2) 1354b, and the compression operating unit (n) 1354c is functionally coupled to the selector (3) 1353a to receive the set of blocked image data as the luminance data from the selector (3) 1353a. Each of the compression operating unit (1) 1354a, the compression operating unit (2) 1354b, and the compression operating unit (n) 1354c is configured to perform a compression operation of the set of blocked image data as the luminance data, thereby generating the second set of compressed and coded data as the luminance data.

The selector (4) 1353b is functionally coupled to the compression operation selecting unit 133 shown in FIG. 19 to receive the compression operation selecting signal from the compression operation selecting unit 133. The selector (4) 1353b is configured to select one of the compression operating unit (1) 1354a, the compression operating unit (2) 1354b, and the compression operating unit (n) 1354c, based on the compression operation selecting signal, thereby receiving the second set of compressed and coded data as the luminance data from the selected one of the compression operating unit (1) 1354a, the compression operating unit (2) 1354b, and the compression operating unit (n) 1354c. The selector (4) 1353b is configured to supply the second set of compressed and coded data as the luminance data to the selector (2) 1352b.

Operations of the compressing and coding unit 135 will be described with reference to FIG. 25. As described above, the image data include the luminance data and the chrominance data. In general, what provides influence to the resolution is the luminance data. In accordance with the normal JPEG compression, the luminance data and the chrominance data are compressed at different compression characteristics. In accordance with this embodiment, in order to allow the compressing and coding unit 135 to perform simplified processes, the luminance data (Y) providing influence to the resolution is subjected to optimum compression realized by the selective compression operation, while the chrominance data (Cb, Cr) being subjected to normal compression realized by the fixed compression operation.

A flag that corresponds to a type of image data is generated by the luminance data flag generating unit 1351. The flag indicates the type of the set of blocked image data input into the compressing and coding unit 135, for example, a luminance data or a chrominance data. If the flag indicates the chrominance data, then the selector (1) 1352a and the selector (2) 1352b select the fixed compression operating unit 1355 so that the fixed compression operating unit 1355 performs the fixed compression operation. If the flag indicates the luminance data, then the selector (1) 1352a and the selector (2) 1352b select the selective compression operating unit 1356 so that the selective compression operating unit 1356 performs the selective compression operation.

The compression operation selecting signal is input into the selective compression operating unit 1356. In the selective compression operating unit 1356, the selector (3) 1353a and the selector (4) 1353b select an optimum one for each block from the compression operating unit (1) 1354a, the compression operating unit (2) 1354b, and the compression operating unit (n) 1354c. The first set of compressed and coded data as the chrominance data and the second set of compressed and coded data as the luminance data are output from the selector (2) 1352b.

The first set of compressed and coded data as the chrominance data and the second set of compressed and coded data as the luminance data are transmitted from the compressing and coding unit 135 through the transmission line 14 to the decoding unit 15. The compression operation selecting signal is also transmitted together with the first and second sets of compressed and coded data from the compressing and coding unit 135 through the transmission line 14 to the decoding unit 15, so that the compression operation selecting signal is used as a decompression operation selecting signal in the decoding unit 15.

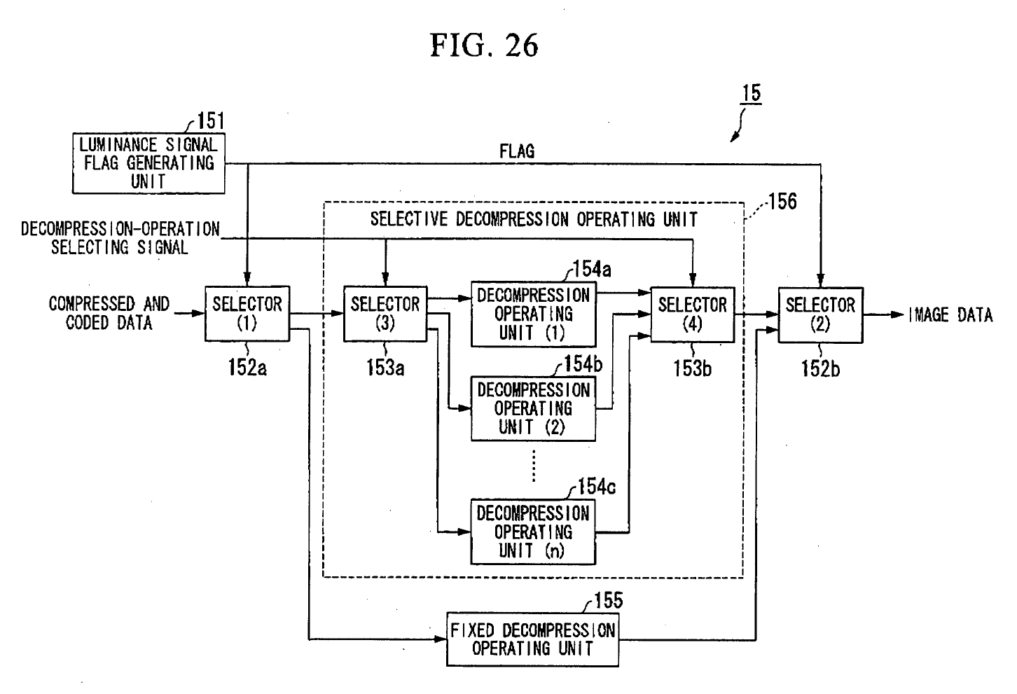

FIG. 26 is a block diagram illustrating a configuration of the decoding unit 15 included in the image processing system shown in FIG. 18. The decoding unit 15 may include, but is not limited to, a luminance data flag generating unit 151 as another flag generating unit, a selector (1) 152a, a selector (2) 152b, a fixed decompression operating unit 155, and a selective decompression operating unit 156.

The luminance data flag generating unit 151 is configured to generate a flag that corresponds to a type of image data. The flag indicates the type of the set of compressed and coded data input into the compressing and coding unit 15, for example, a luminance data or a chrominance data.

The selector (1) 152a is functionally coupled to the coding unit 13 shown in FIG. 18 to receive the set of compressed and coded data from the coding unit 13. The selector (1) 152a is functionally coupled to the luminance data flag generating unit 151 to receive the flag from the luminance data flag generating unit 151. If the flag indicates the luminance data for the set of input compressed and coded data, then the selector (1) 152a selects the selective decompression operating unit 156 to supply the set of compressed and coded data as the luminance data to the selective decompression operating unit 156. If the flag indicates the chrominance data for the set of input compressed and coded data, then the selector (1) 152a selects the fixed decompression operating unit 155 to supply the set of compressed and coded data as the chrominance data to the fixed decompression operating unit 155.

The fixed decompression operating unit 155 is functionally coupled to the selector (1) 152a to receive the set of compressed and coded data as the chrominance data from the selector (1) 152a, if the flag indicates the chrominance data for the set of input compressed and coded data. The fixed decompression operating unit 155 is configured to perform a fixed decompression operation of the set of compressed and coded data as the chrominance data, thereby generating a first set of decompressed data as the chrominance data.

The selective decompression operating unit 156 is functionally coupled to the selector (1) 152a to receive the set of compressed and coded data as the luminance data from the selector (1) 152a, if the flag indicates the luminance data for the set of input compressed and coded data. The selective decompression operating unit 156 is functionally coupled to the coding unit 13 shown in FIG. 18 to receive the decompression operation selecting signal from the coding unit 13. The selective decompression operating unit 156 is configured to perform a selective decompression operation of the set of compressed and coded data as the luminance data, thereby generating a second set of decompressed data as the luminance data.

The selector (2) 152b is functionally coupled to the luminance data flag generating unit 151 to receive the flag from the luminance data flag generating unit 151. If the flag indicates the luminance data for the set of input compressed and coded data, then the selector (2) 152b selects the selective decompression operating unit 156 to receive the second set of decompressed data as the luminance data from the selective decompression operating unit 156. The selector (2) 152b outputs the second set of decompressed data as the luminance data. If the flag indicates the chrominance data for the set of input compressed and coded data, then the selector (2) 152b selects the fixed decompression operating unit 155 to receive the first set of decompressed data as the chrominance data from the fixed decompression operating unit 1355. The selector (2) 152b outputs the first set of decompressed data as the chrominance data The selective compression operating unit 156 may further include, but is not limited to, a selector (3) 153a; a selector (4) 153b, a decompression operating unit (1) 154a, a decompression operating unit (2) 154b, and a decompression operating unit (n) 154c.

The selector (3) 153a is functionally coupled to the selector (1) 152a to receive the set of compressed and coded data as the luminance data from the selector (1) 152a, if the flag indicates the luminance data for the set of input compressed and coded data The selector (3) 153a is functionally coupled to the coding unit 13 shown in FIG. 18 to receive the decompression operation selecting signal from the coding unit 13. The selector (3) 153a is configured to select one of the decompression operating unit (1) 154a, the decompression operating unit (2) 154b, and the decompression operating unit (n) 154c, based on the decompression operation selecting signal, thereby receiving the set of compressed and coded data as the luminance data to a selected one of the decompression operating unit (1) 154a, the decompression operating unit (2) 154b, and the decompression operating unit (n) 154c.

Each of the decompression operating unit (1) 154a, the decompression operating unit (2) 154b, and the decompression operating unit (n) 154c is functionally coupled to the selector (3) 153a to receive the set of compressed and coded data as the luminance data from the selector (3) 153a. Each of the decompression operating unit (1) 154a, the decompression operating unit (2) 154b, and the decompression operating unit (n) 154c is configured to perform a decompression operation of the set of compressed and coded data as the luminance data, thereby generating the second set of decompressed data as the luminance data.

The selector (4) 153b is functionally coupled to the coding unit 13 shown in FIG. 18 to receive the decompression operation selecting signal from the coding unit 13. The selector (4) 153b is configured to select one of the decompression operating unit (1) 154a, the decompression operating unit (2) 154b, and the decompression operating unit (n) 154c, based on the compression operation selecting signal, thereby receiving the second set of decompressed data as the luminance data from the selected one of the decompression operating unit (1) 154a, the decompression operating unit (2) 154b, and the decompression operating unit (n) 154c. The selector (4) 153b is configured to supply the second set of decompressed data as the luminance data to the selector (2) 152b.

Operations of the decoding unit 15 will be described with reference to FIG. 26. Similarly to the coding unit 13, the flag indicating the luminance data or the chrominance data for the set of input compressed and coded data is output from the luminance data flag generating unit 151. If the flag indicates the chrominance data, then the selector (1) 152a and the selector (2) 152b select the fixed decompression operating unit 155 to perform the fixed decompression operation of the set of input compressed and coded data as the chrominance data.

If the flag indicates the luminance data, then the selector (1) 152a and the selector (2) 152b select the selective decompression operating unit 154 to perform the selective decompression operation of the set of input compressed and coded data as the luminance data. The set of the compressed and coded data is input into the selective decompression operating unit 156. A corresponding one of the plural different decompression operations for decompressing the set of compressed and coded data as the luminance data is selected based on the decompression operation selecting signal. The selected corresponding one is a decompression operation that corresponds to the selected compression operation. In the selective decompression operating unit 156, the selector (3) 153a and the selector (4) 153b select an optimum one for each block of the decompression operating unit (1) 154a, the decompression operating unit (2) 154b, and the decompression operating unit (n) 154c. The second set of decompressed data is output -from the selector (2) 152b.

A predetermined variety of image processes is applied to the set of decompressed data before the image is displayed by and stored in the image storing/display unit 16. In accordance with the present embodiment, the image data includes the luminance data and the chrominance data. The above system can be applied, when the image data consists of color signals R, G, and B. The G signal is most influential to the resolution. Thus, the G signal is subjected to the selective compression operation, and the R signal and the B signal are subjected to the fixed compression operation.

As described above, the present embodiment provides the following additional effects in addition to the effects described above with regard to the first embodiment. As described with reference to FIG. 22, the selection of the compression operation for the current block is made based on the result of selecting the compression operation for a block that is positioned adjacent to the current block. This can prevent any remarkable difference in compressing and coding characteristics between the current block and the adjacent block, thereby reducing a difference in quality between the current and adjacent blocks.

The flag signal is used to distinguish the type of image data, for example, the luminance and chrominance data. The chrominance data is less influential to the quality of image. The chrominance data is subjected to the normal compressing and coding operation. The luminance data is influential to the quality of image. The luminance data is subjected to the selective compression operation. The selective compression operation is selectively applied to the image data.

For compressing and coding the image data, the compression operating unit is selected that corresponds to the amount of optical distortion of the optical system. This allows the compression and coding operations without causing any substantial deterioration of the image quality and any remarkable increase of the data amount. This means that the substantial deterioration of the image quality can be prevented while compressing and coding the image captured by the distortion-containing optical system.

In accordance with the above-described embodiments, the area of image is divided into three concentric areas. The number of divided areas or divided blocks should not be limited to three. The shape of divided areas or divided blocks can be modified.

In accordance with the above-described embodiments, a combination of cylindrical lenses is used as the distortion-containing optical system. Coaxial optical systems having distortion can be used.

The coding unit and the decoding unit are paired to form one-to-one correspondence. It is possible as a modification that a single coding unit is functionally coupled to a plurality of decoding units. It is also possible as a further modification that a plurality of coding units is functionally coupled to a single decoding unit.

It is possible that the coding unit and the decoding unit are accommodated or integrated in a single apparatus. It is also possible as a modification that the coding unit is accommodated in an apparatus, and the decoding unit is provided in an outer apparatus such as an external computer.

The term “unit” is used to describe a component, section or part of a device includes hardware and/or software that is constructed and/or programmed to carry out the desired function.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image coding apparatus comprising:
a distortion determining unit configured to determine an amount of optical distortion of an image associated with a set of input image data;
a plurality of compression operating units that have different compression and coding characteristics from each other, each of the plurality of compression operating units being configured to convert at least a part of the set of input image data into a corresponding set of compressed and coded data; and
a selecting unit configured to select one of the plurality of compression operating units with reference to the result of determination by the distortion determining unit.

2. The image coding apparatus according to claim 1, further comprising:
a block-dividing unit configured to divide the set of input image data into a plurality of divided blocks, and
wherein the distortion determining unit is configured to determine the amount of optical distortion for each of the plurality of divided blocks, and
the plurality of compression operating units is configured to convert a part of the set of input image data for each of the plurality of divided blocks.

3. The image coding apparatus according to claim 2, further comprising:
a selection result storing unit configured to store a result of selection by the selecting unit for each of the plurality of divided blocks; and
a selection signal generating unit configured to generate a selection signal that selects one of the plurality of compression operating units for converting a current block into a set of compressed and coded data, based on the result of determination by the distortion determining unit for the current block and based on the result of selection supplied from the selection result storing unit for a block adjacent to the current block.

4. The image coding apparatus according to claim 1, wherein the selecting unit comprises:
a flag output unit that outputs a flag signal that shows the type of the set of image data;
a normal compression operating unit configured to convert the set of image data into a set of compressed and coded data by a single compression and coding characteristic; and
a selector configured to select one of the normal compression operating unit and the plurality of compression operating units based on the flag signal.

5. An image processing system comprising:
an image coding apparatus further comprising:
a distortion determining unit configured to determine an amount of optical distortion of an image associated with a set of input image data;
a plurality of compression operating units that have different compression and coding characteristics from each other, each of the plurality of compression operating units being configured to convert at least a part of the set of input image data into a first set of compressed and coded data;
a compression and coding selecting unit configured to select one of the plurality of compression operating units with reference to the result of determination by the distortion determining unit; and
a normal compression operating unit configured to convert the set of image data into a second set of compressed and coded data by a single compression and coding characteristic; and
an image decoding apparatus further comprising:
a plurality of decompression operating units that have decompression characteristics being different from each other and corresponding to the compression and coding characteristics of the plurality of compression operating units respectively, each of the plurality of decompression operating units being configured to convert the first set of compressed and coded data into a first set of decompressed image data;
a decompression selecting unit configured to select one of the plurality of decompression operating units, the selected one decompression operating unit having a decompression characteristic that corresponds to the compression and coding characteristic of the selected one compression operating unit;
a normal decompression unit configured to convert the second set of compressed and coded data into a second set of decompressed image data;
an image replacing unit configured to replace a corresponding portion of the second set of decompressed image data that corresponds to a predetermined area of image into the first set of decompressed image data that corresponds to the predetermined area of image, thereby generating a third set of decompressed image data;
a selector configured to select the second set of decompressed image data or the third set of decompressed image data, based on a mode signal input from the outside.

6. An image processing system comprising:
an image coding apparatus further comprising:
a distortion determining unit configured to determine an amount of optical distortion of an image associated with a set of input image data;
a plurality of compression operating units that have different compression and coding characteristics from each other, each of the plurality of compression operating units being configured to convert at least a part of the set of input image data into a set of compressed and coded data; and
a compression and coding selecting unit configured to select one of the plurality of compression operating units with reference to the result of determination by the distortion determining unit; and
an image decoding apparatus further comprising:
a plurality of decompression operating units that have decompression characteristics being different from each other and corresponding to the compression and coding characteristics of the plurality of compression operating units respectively, each of the plurality of decompression operating units being configured to convert the set of compressed and coded data into a set of decompressed image data;
a decompression selecting unit configured to select one of the plurality of decompression operating units, the selected one decompression operating unit having a decompression characteristic that corresponds to the compression and coding characteristic of the selected one compression operating unit; and
an image connecting unit configured to connect the sets of decompressed image data.
